(19) United States
(12) Patent Application Publication
(10) Pub. No.: US 2013/0261032 A1
(43) Pub. Date: Oct. 3, 2013

(54) ADDITIVE FOR SUBTERRANEAN TREATMENT

(71) Applicant: SCHLUMBERGER TECHNOLOGY CORPORATION, Sugar Land, TX (US)

(72) Inventors: Hemant K. J. Ladva, Missouri City, TX (US); Carlos Abad, Richmond, TX (US)

(73) Assignee: Schlumberger Technology Corporation, Sugar Land, TX (US)

(21) Appl. No.: 13/852,665

(22) Filed: Mar. 28, 2013

Related U.S. Application Data
(60) Provisional application No. 61/617,148, filed on Mar. 29, 2012.

(51) Int. Cl. C09K 8/00; E21B 33/13

(52) U.S. Cl. CPC C09K 8/00; E21B 33/13
USPC 507/131; 166/292; 507/240; 507/219

(57) ABSTRACT

A method of treating a subterranean formation by forming a treatment fluid that contains at least a non-surface active substituted ammonium containing aminoacid derivative. The treatment fluid may then be introduced to the subterranean formation.

### CROSS REFERENCE

This application claims the benefit of a related U.S. Provisional Application Ser. No. 61/617,148, which was filed on Mar. 29, 2012, entitled “ADDITIVE FOR SUBTERRANEAN TREATMENT,” to Abad et al., the disclosure of which is incorporated herein by reference in its entirety.

### BACKGROUND

Hydrocarbons (oil, natural gas, etc.) may be obtained from a subterranean geologic formation (a “reservoir”) by drilling a well that penetrates the hydrocarbon-bearing formation. Well treatment methods often are used to increase hydrocarbon production by using a chemical composition or fluid, such as a treatment fluid.

The use of treatment fluids containing environmentally friendly materials in oilfield industries is desirable as most chemical compositions that are not considered environmentally friendly or “green” may have potential harmful effects on both persons and/or the environment. To address this issue, “green” chemical replacements are often desired.

### SUMMARY

In embodiments, disclosed herein is a method of treating a subterranean formation by forming a treatment fluid that contains at least a non-surface active substituted ammonium containing aminoacid derivative. The treatment fluid may then be introduced to the subterranean formation.

### BRIEF DESCRIPTION OF DRAWINGS

The manner in which the objectives of the present disclosure and other desirable characteristics may be obtained is explained in the following description and attached drawings in which:

FIG. 1 is a plot of the viscosity as a function of the time and temperature for a sample containing a non-surface active substituted ammonium containing aminoacid;

FIG. 2 shows a plot of the viscosity as a function the time and temperature for a sample containing a non-surface active substituted ammonium containing aminoacid;

FIG. 3 shows a plot of the viscosity as a function the time and temperature for a sample containing a non-surface active substituted ammonium containing aminoacid;

FIG. 4 shows a plot of the viscosity as a function the time and temperature for a sample containing a non-surface active substituted ammonium containing aminoacid;

FIG. 5 is a schematic diagram for a radial capillary suction time apparatus;

FIG. 6 is a plot of the capillary suction time as a function of the concentration of trimethyl glycine in a clay suspension;

FIG. 7 is a plot of the capillary suction time as a function of the concentration of trimethyl glycine solution without clay;

FIG. 8 is a plot of the cumulative fluid loss as a function of time;

FIG. 9 is an illustration of the clay suspension properties of trimethyl glycine solutions;

FIG. 10 is multitude of illustrations comparing the clay suspension properties trimethyl glycine solutions with other salt solutions;

FIG. 11 shows a plot of the gel strength measured as a function of time for cementing compositions containing trimethyl glycine; and

FIG. 12 shows a plot of the viscosity measured as a function of % trimethyl glycine for cementing compositions.

### DETAILED DESCRIPTION

In the following description, numerous details are set forth to provide an understanding of the present disclosure. However, it may be understood by those skilled in the art that the methods of the present disclosure may be practiced without these details and that numerous variations or modifications from the described embodiments may be possible.

At the outset, it should be noted that in the development of any such actual embodiment, numerous implementation—specific decisions may be made to achieve the developer's specific goals, such as compliance with system related and business related constraints, which will vary from one implementation to another. Moreover, it will be appreciated that such a development effort might be complex and time consuming but would nevertheless be a routine undertaking for those of ordinary skill in the art having the benefit of this disclosure. In addition, the composition used/disclosed herein can also comprise some components other than those cited. In the summary and this detailed description, each numerical value should be read once as modified by the term “about” (unless already expressly so modified), and then read again as not so modified unless otherwise indicated in context. Also, in the summary and this detailed description, it should be understood that a range listed or described as being useful, suitable, or the like, is intended to include support for any conceivable sub-range within the range at least because every point within the range, including the end points, is to be considered as having been stated. For example, “a range of from 1 to 10” is to be read as indicating each possible number along the continuum between about 1 and about 10. Furthermore, one or more of the data points in the present examples may be combined together, or may be combined with one of the data points in the specification to create a range, and thus include each possible value or number within this range. Thus, (1) even if numerous specific data points within the range are explicitly identified, (2) even if reference is made to a few specific data points within the range, or (3) even when no data points within the range are explicitly identified, it is to be understood (i) that the inventors appreciate and understand that any conceivable data point within the range is to be considered to have been specified, and (ii) that the inventors possessed knowledge of the entire range, each conceivable sub-range within the range, and each conceivable point within the range. Furthermore, the subject matter of this application illustratively disclosed herein suitably may be practiced in the absence of any element(s) that are not specifically disclosed herein.

The methods of the present disclosure relate to introducing fluids comprising non-surface active substituted ammonium containing aminoacids. Such treatment fluids may be introduced during methods that may be applied at any time in the life cycle of a reservoir, field or oilfield; for example, the methods and treatment fluids of the present disclosure may be employed in any desired downhole application (such as, for example, stimulation) at any time in the life cycle of a reservoir, field or oilfield.

The term “treatment fluid,” refers to any fluid used in a subterranean operation in conjunction with a desired function and/or for a desired purpose. The term “treatment,” or “treating,” does not imply any particular action by the fluid. For example, a treatment fluid (such as a treatment fluid comprising a non-surface active substituted ammonium containing aminoacid derivatives) introduced into a subterranean formation subsequent to a leading-edge fluid may be a hydraulic fracturing fluid, an acidizing fluid (acid fracturing, acid diverting fluid), a stimulation fluid, a sand control fluid, a completion fluid, a wellbore consolidation fluid, a remediation treatment fluid, a cementing fluid, a drilling fluid, a frac-packing fluid, a gravel packing fluid, a loss circulation pill, or a well or pipe clean out treatment. The methods of the present disclosure in which a non-surface active substituted ammonium containing aminoacid derivatives is employed, and treatment fluids comprising a non-surface active substituted ammonium containing aminoacid derivatives may be used in full-scale operations, pills, or any combination thereof. As used herein, a “pill” is a type of relatively small volume of specially prepared treatment fluid, such as a treatment fluid comprising a substituted ammonium containing aminoacid derivatives, placed or circulated in the wellbore.

The term “fracturing” refers to the process and methods of breaking down a geological formation and creating a fracture, such as the rock formation around a wellbore, by pumping fluid at very high pressures (pressure above the determined closure pressure of the formation), in order to increase production rates from or injection rates into a hydrocarbon reservoir. The fracturing methods of the present disclosure may include a substituted ammonium containing aminoacid derivatives in one or more of the treatment fluids, but otherwise use conventional techniques known in the art.

In embodiments, the treatment fluids of the present disclosure may be introduced into a wellbore. A “wellbore” may be any type of well, including, but not limited to, a producing well, a non-producing well, an injection well, a fluid disposal well, an experimental well, an exploratory well, and the like. Wellbores may be vertical, horizontal, deviated some angle between vertical and horizontal, and combinations thereof, for example a vertical well with a non-vertical component.

The term “field” includes land-based (surface and sub-surface) and sub-seabed applications. The term “oilfield,” as used herein, includes hydrocarbon oil and gas reservoirs, and formations or portions of formations where hydrocarbon oil and gas are expected but may additionally contain other materials such as water, brine, or some other composition.

The term “amphiphilic” refers to surfactant-like chemical substances comprising hydrophilic moieties that provide a polar water soluble structure (often referred to as polar head) and hydrophobic moieties or chains (often referred to as hydrophobic tail sufficiently long to allow for “partial solubility” of the molecule in water or brine so as to form micellar structures. In the foregoing the terms “surface active”, and “partially water soluble” will be used to refer in the foregoing to betaine type structures capable of forming micelles.

By contrast the terms “non amphiphilic”, “non-surface active” or “substantially water soluble” will be used herein to interchangeably refer to organic compounds that do not form micelles when dissolved in water, in particular to betaine type structures that are incapable of forming micelles.

Disclosed herein is a composition of matter, and methods of treatment comprising non-surface active substituted ammonium containing aminoacid derivatives of Formula 1:

R₁R₂R₃N⁺—R₄—CO₂⁻ (1)

or non-surface active substituted ammonium containing aminoacid derivatives of Formula 2:

[R₁R₂R₃N⁺—R₄—CO₂H]A⁻ (2)

wherein R₁, R₂, and R₃, are, independently of each other, short chain hydrocarbon structures of the same or different nature. In the foregoing, the phrase “short chain hydrocarbon structures” is defined as a hydrocarbon chemical radical of formula CₓH_{2x+y}, where x is an integer between 1 and 8 and y is an integer between −4 and +2. Structures that can be considered as short chain hydrocarbon structures are radicals such as: i) saturated alkyl groups, such as, for example, a methyl, ethyl, propyl, butyl, pentyl, hexyl, heptyl, octyl or a nonyl group; ii) branched alkyl groups such as, for example, 2-ethyl hexyl, iso-octyl, isopropyl, isobutyl, isopentyl, tert-butyl, and the like; iii) unsaturated alkyl groups such as alkenes and alkynes; iv) functional hydrocarbon radicals such as those derived from methanol, ethanol, isopropanol, and the like; or structures where R₁ and R₂ combine to form an alicyclic structure, such as monocyclic cycloalkenes such as cyclopropene, azyridine, cyclobutene, azetidine, cyclopentene, pyrrolidine, pyrrole, cyclohexene, cycloheptene, cyclooctene, and the like; or where R₁, R₂, and R₃, combine to form an aromatic structure such as pyridinine; wherein R₄ is an n-alkylene radical such as methylene, ethylene, propylene, butylenes, and the like (the n-alkylene radical may be functionalized with at least one functional group such as an amino group (—NH₂), a hydroxyl group (—OH), or a thiol group (—SH)—examples being 2-hydroxypropylene, 2-aminopropylene, or 2-thiopropylene) and where A⁻ is the conjugated base of neutralizing acid or natural origin such as hydrochloric (Cl⁻, chloride), acetic (CH₃COO⁻, acetate), formic (HCOO⁻, formate), glycolic (OH—CH2-COO—, glycolate), lactic (CH₃—CH(OH)—COO—, lactate), citric (citrate), and the like.

Also disclosed herein is a composition of matter, and methods of treatment comprising a non-surface active substituted ammonium containing aminoacid salts of Formula 3:

[R₁R₂R₃N⁺—R₄—CO₂]_{z}M (3)

wherein M is a metal ion of charge positive charge, z is an integer between +1 and +4, examples of M being Na⁺, K⁺, Ca²⁺, Mg²⁺, Zn²⁺, Fe²⁺, Fe³⁺, and the like; wherein R₁, R₂, R₃, are, independently of each other, hydrocarbon structures of different nature such as: i) saturated alkyl groups, such as, for example, a methyl, ethyl, propyl, butyl, pentyl, hexyl, heptyl, octyl or a nonyl group, ii) branched alkyl groups such as 2-ethyl hexyl, iso-octyl, isopropyl, isobutyl, isopentyl, tert-butyl, and the like, iii) unsaturated alkyl groups such as alkenes, alkynes iv) functional hydrocarbon radicals such as those derived from methanol, ethanol, isopropanol, and the like; or structures where R₁ and R₂ combine to form an alicyclic structure, such as monocyclic cycloalkenes such as cyclopropene, azyridine, cyclobutene, azetidine, cyclopentene, pyrrolidine, pyrrole, cyclohexene, cycloheptene, cyclooctene, and the like; or where R₁, R₂, and R₃, combine to form an aromatic structure such as, pyridinine; wherein R₄ is an n-alkylene radical such as methylene, ethylene, propylene, butylenes, and the like.

Also disclosed herein is a composition of matter, and methods of treatment comprising a non-surface active substituted ammonium containing aminoacid salts of Formula 4:

[R₁R₂R₃N⁺—R₄—CO₂H]ₜA^{t-} (4)

wherein A^{t-} is a conjugated base of a polyprotic neutralizing acid of charge t−, where t is an integer between 2 and 4, such as sulfuric (SO₄²⁻), phosphoric (PO₄³⁻), and the like, and wherein R₁, R₂, R₃, are, independently of each other, hydrocarbon structures of different nature such as: i) saturated alkyl groups, such as, for example, a methyl, ethyl, propyl, butyl, pentyl, hexyl, heptyl, octyl or a nonyl group, ii) branched alkyl groups such as 2-ethyl hexyl, iso-octyl, isopropyl, isobutyl, isopentyl, tert-butyl, and the like, iii) unsaturated alkyl groups such as alkenes, alkynes iv) functional hydrocarbon radicals such as those derived from methanol, ethanol, isopropanol, and the like; or structures where R₁ and R₂ combine to form an alicyclic structure, such as monocyclic cycloalkenes such as cyclopropene, azyridine, cyclobutene, azetidine, cyclopentene, pyrrolidine, pyrrole, cyclohexene, cycloheptene, cyclooctene, and the like; or where R₁, R₂, and R₃, combine to form an aromatic structure such as, pyridinine; wherein R₄ is an n-alkylene radical such as methylene, ethylene, propylene, butylenes, and the like. Also R₄ can comprise at least one functional group such as amino (—NH₂), hydroxyl (—OH), or thiol (—SH) as a substituent on the alkylene radical such as 2 hydroxypropylene, 2 aminopropylene, or 2 thiopropylene, and the like.

The structures disclosed in Formulas 1, 2, 3 and 4 are substantially water soluble and therefore “non amphiphilic” and “non-surface active” and do not form micelles in water, as opposed to other amphiphilic betaine structures used in the oilfield as surfactants and viscoelastic surfactants that are partially water soluble, surface active, and micelle forming. In general, for a betaine structure to be amphiphilic, micelle forming, or surface active the hydrocarbon chain should be sufficiently long, such as for example, from about 8 to about 26 carbon atoms to counteract the hydrophilicity of the polar zwitterionic structure formed by the charged nitrogen atom and the carboxylate structure, and become amphipilic, or micelle forming. Examples of betaine surfactants structures commonly used in the oilfield include those listed in U.S. Pat. No. 7,387,986 B2, which is incorporated by reference herein in its entirety, and discloses an oilfield treatment method consisting of preparing and injecting down a well a fluid containing a viscoelastic surfactant selected from zwitterionic, amphoteric, and cationic surfactants and mixtures of those surfactants, and a rheology enhancer in a concentration sufficient to shorten the shear recovery time of the fluid. Additional betaine surfactants are described in U.S. Pat. No. 6,703,352 B2, which is incorporated by reference herein in its entirety, and discloses oilfield uses of zwitterionic surfactants comprising a hydrophobic moiety of alkyl, alkylarylalkyl, alkoxyalkyl, alkylaminoalkyl and alkylamidoalkyl, wherein alkyl represents a group that contains from about 12 to about 24 carbon atoms which may be branched or straight chained and which may be saturated or unsaturated.

One family of such compounds based upon Formula 1 are the trialkyl glycines, where the R₄ group in Formula 1 is methylene (—CH₂—) and R₁, R₂ and R₃, independently of each other are alkyl groups. Specific examples trialkyl glycines include trimethyl glycine (TMG) (also referred to as betaine), triethylglycine, tripropylglycine, triisopropylglycine. Other compounds with similar structures are N,N,N-trimethylalanine, N,N,N-triethylalanine, N,N,N-triisopropylalanine, N,N,N-trimethylmethylalanine. Other structures where the hydrocarbon R₄ group in Formula 1 contains a functional group such as amino or hydroxyl are carnitine and acetyl carnitine.

TMG, trimethyl glycine, is an environmentally friendly product that has a wide range for potential applications in the oil industry. The formula for TMG is shown below.

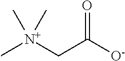

As used herein, the phrase “trimethyl glycine” (TMG) or the term “betaine” may refer to trimethyl glycine monohydrate or the active derivatives thereof. The active derivatives refer to organic salts of trimethyl glycine, such as citrates, acetates and formates, which form TMG in aqueous solutions. TMG is considered to be an excellent resource of methyl groups, (CH₃).

Trimethylglycine is a N-trimethylated amino acid. This quaternary ammonium ion exists as the zwitterion at a neutral pH. Additional N-trimethylated amino acids may be included. Strong acids, such as hydrochloric acid may convert TMG to the salt betaine hydrochloride, as illustrated in the below chemical reaction.

(CH₃)₃N⁺CH₂CO₂⁻+HCl→[(CH₃)₃N⁺CH₂CO₂H]Cl⁻

Furthermore, TMG may be derived from natural sources, for instance extracted from sugar beets, spinach or broccoli or various other plants and animals. For example, the processing of a sucrose sugar from sugar beets yields TMG as a byproduct and often involves chromotographic separation. TMG may also be biosynthesized by the oxidation of choline in following two steps: (1) the intermediate, betaine aldehyde is generated by the action of the enzyme mitochondrial choline oxidase and (2) the detaine aldehyde is further oxidized in the mitochondria or cytoplasm using the enzyme called betaine aldehyde dehydrogenase. Anhydrous trimethyl glycine has been approved by the Food and Drug Administration of the United States (under the brand name Cystadane) for the treatment of homocystinuria, a disease caused by abnormally high homocysteine levels at birth.

Furthermore, TMG is a non-toxic material that lacks any odor. TMG also has very large an acute oral toxicity, LD₅₀, that is greater than 10,000 mg/kg (a large intake can be tolerated prior to the product becoming toxic), which is greater than other conventional fluids presently used in similar oilfield applications, such as, for example, ethylene glycol (LD₅₀ of 4700 mg/kg), propylene glycol (LD₅₀ of 20,000 mg/kg), ethanol (LD₅₀ of 7060 mg/kg). TMG also biodegrades in nature rapidly compared to conventional fluids. Trimethyl glycine or TMG thus represents a reasonably safe and non-toxic alternative to various other well treatment fluids, such as alcohols and glycols used in the oilfield industry. Examples of these treatment fluids include those discussed above, such as ethylene glycol, propylene glycol and ethanol.

The non-surface active substituted ammonium containing aminoacid derivatives discussed above may also be encapsulated so as to be released downhole at a preset time. Suitable examples of encapsulating materials include synthetic and natural polymers, and waxes and lipids. Examples amongst the synthetic polymers are polyesters, polyamides, vinyl ester copolymers, acrylate copolymers, vinylidene chloride/methylacrylate copolymers, and the like. Examples amongst the natural or naturally derived polymers are starch and its derivatives, cellulose and its derivatives, gum arabic, gum karaya, mesquite gum, galactomannans, soluble soybean, gluten (corn), carrageenan, alginate, xanthan, gellan, dextran, chitosan, caseins, whey proteins, gelatin, and the like. Examples amongst the phospholipids and waxes include fatty acids/alcohols, glycerides, low molecular weight synthetic waxes, bee wax, candle wax, and the like

Micro-encapsulation is a process in which tiny particles or droplets are surrounded by a coating to give small capsules of many useful properties. In a relatively simplistic form, a microcapsule is a small sphere with a uniform wall around it. The material inside the microcapsule is referred to as the core, internal phase, or fill, whereas the wall is sometimes called a shell, coating, or membrane. Methods to encapsulate include but are not limited to pan coating, air-suspension coating, centrifugal extrusion, vibrational nozzle, spray-drying, ionotropic gelation, coacervation-phase separation, interfacial polycondensation or cross-linking, in-situ polymerization, and matrix polymerization.

In another embodiment, non-surface active substituted ammonium containing aminoacid derivatives, and in particular substituted glycines, and more in particular trimethyl glycine may be used as an environmentally compatible clay suspending agent and fluid loss reducer in conjunction with clays.

In another embodiment, non-surface active substituted ammonium containing aminoacid derivatives, and in particular substituted glycines, and more in particular trimethyl glycine can be used to delay the crosslinking of a well treatment fluid.

In another embodiment, non-surface active substituted ammonium containing aminoacid derivatives, and in particular substituted glycines, and more in particular trimethyl glycine can be used to depress the pour point of additives required to formulate a well treatment fluid.

In another embodiment, non-surface active substituted ammonium containing aminoacid derivatives, and in particular substituted glycines, and more in particular trimethyl glycine can be used to reduce the freezing point of a well treatment fluid.

The non-surface active substituted ammonium containing aminoacid derivative, and in particular substituted glycines, and more in particular trimethyl glycine may be present in any of the composition described herein in an amount of from about 0.1 wt % to about 80 wt %, 5 wt % to about 70 wt %, of from about 10 wt % to about 60 wt %, of from about 20 wt % to about 50 wt %, from about 30 wt % to about 40 wt %, based upon the overall weight of the fluid.

In another embodiment, non-surface active substituted ammonium containing aminoacid derivatives, and in particular substituted glycines, and more in particular trimethyl glycine may be used as an environmentally friendly hydrate inhibitor that effectively prevents the formation of water and methane hydrates or clathrates.

As discussed above, multiple oilfield uses and purposes of the non-surface active substituted ammonium containing aminoacid derivatives, and in particular substituted glycines, more in particular trimethyl glycine (TMG) are disclosed herein. In one embodiment, the non-surface active substituted ammonium containing aminoacid derivatives may be used as an additive in conventional well treatment fluids used in fracturing, cementing, sand control, shale stabilization, fines migration, drilling fluid, friction pressure reduction, loss circulation, well clean out, and the like. The presence the non-surface active substituted ammonium containing aminoacid derivatives in the well treatment fluid may act as a fluid loss reduction enhancing agent and/or clay suspending agent for any of the above-listed processes.

### Fracturing Fluid

Hydrocarbons (oil, natural gas, etc.) are obtained from a subterranean geological formation by drilling a well that penetrates the hydrocarbon-bearing formation. This provides a partial flow path for the hydrocarbon to reach the surface. In order for the hydrocarbon to be “produced,” that is, travel from the formation to the wellbore and ultimately to the surface, there must be a sufficiently unimpeded flow path.

Hydraulic fracturing is a primary tool for improving well productivity by placing or extending highly conductive fractures from the wellbore into the reservoir. During the first stage, hydraulic fracturing fluid is injected through wellbore into a subterranean formation at high rates and pressures. The fracturing fluid injection rate exceeds the filtration rate into the formation producing increasing hydraulic pressure at the formation face. When the pressure exceeds a critical value, the formation strata or rock cracks and fractures. The formation fracture is more permeable than the formation porosity.

During the next stage, proppant is deposited in the fracture to prevent it from closing after injection stops. The resulting propped fracture enables improved flow of the recoverable fluid, i.e., oil, gas or water. Sand, gravel, glass beads, walnut shells, ceramic particles, sintered bauxites, mica and other materials may be used as a proppant.

Hydraulic fracturing fluids are aqueous solutions containing a thickener, such as a solvatable polysaccharide, a solvatable synthetic polymer, or a viscoelastic surfactant, that when dissolved in water or brine provides sufficient viscosity to transport the proppant. Typical thickeners are polymers, such as guar (phytogeneous polysaccharide), and guar derivatives (hydroxypropyl guar, carboxymethylhydroxypropyl guar). Other synthetic polymers such as polyacrylamide copolymers can be used also as thickeners. Water with guar represents a linear gel with a viscosity proportional to the polymer concentration. Cross-linking agents may be used which provide engagement between polymer chains to form sufficiently strong couplings that increase the gel viscosity and create visco-elasticity. Common crosslinking agents for guar and its derivatives and synthetic polymers include boron, titanium, zirconium, and aluminum. Another class of non-polymeric viscosifiers includes the use of viscoelastic surfactants that form elongated micelles.

### Particulate Agglomeration

Proppant-retention agents are commonly used during the latter stages of the hydraulic fracturing treatment to limit the flowback of proppant placed into the formation. For instance, the proppant may be coated with a curable resin activated under downhole conditions. Different materials, such as bundles of fibers, or fibrous or deformable materials, also have been used to retain proppants in the fracture. Presumably, fibers form a three-dimensional network in the proppant, reinforcing it and limiting its flowback. At times, due to weather, humidity, contamination, or other environmental uncontrolled conditions, some of these materials can aggregate and/or agglomerate, making it difficult to control their accurate delivery to wellbores in well treatments.

Non-surface active substituted ammonium containing aminoacid derivatives, and in particular substituted glycines, such as those described herein can be used in fluid mixtures to prevent agglomeration of particulate products or particulates, sand, bauxite, ceramic, polymers, and the like additives that are used in the oilfield particularly in sub ambient temperatures, especially below freezing conditions where moisture can typically result in particle agglomeration. More specifically, non-surface active substituted ammonium containing aminoacid derivatives, and in particular substituted glycines may help in preventing particulate cohesion by applying the substituted glycines by any suitable application method, such as spraying/coating particles, to the particulate.

The success of a hydraulic fracturing treatment depends upon hydraulic fracture conductivity and fracture length. Fracture conductivity is the product of proppant permeability and fracture width; units are typically expressed as millidarcy-feet. Fracture conductivity is affected by a number of known parameters. Proppant particle size distribution is one key parameter that influences fracture permeability. The concentration of proppant between the fracture faces is another (expressed in pounds of proppant per square foot of fracture surface) and influences the fracture width. One may consider high-strength proppants, fluids with excellent proppant transport characteristics (ability to minimize gravity-driven settling within the fracture itself), high-proppant concentrations, or big proppants as means to improve fracture conductivity. Weak materials, poor proppant transport, and narrow fractures all lead to poor well productivity. Relatively inexpensive materials of little strength, such as sand, are used for hydraulic fracturing of formations with small internal stresses. Small sand grains (100 mesh, 70-140 mesh) are becoming quite prevalent in shale formations. Materials of greater cost, such as ceramics, bauxites and others, are used in formations with higher internal stresses. Chemical interaction between produced fluids and proppants may change significantly the proppant's characteristics. One should also consider the proppant's long-term ability to resist crushing.

The result of multiplying fracture permeability by fracture width is referred to as hydraulic conductivity. An important aspect of fracture design is optimization of the hydraulic conductivity for a particular formation's conditions. Fracture design theory and methodology are sufficiently well described in several scientific articles and monographs. Reservoir Stimulation, 3.sup.rd ed. Economides, Michael J. and Nolte, Kenneth G., John Wiley and Sons (1999) is a good example of a reference that provides good fracture design methodology.

A fracture optimization process will strike a balance among the proppant strength, hydraulic fracture conductivity, proppant distribution, cost of materials, and the cost of executing a hydraulic fracturing treatment in a specific reservoir. The case of big proppants illustrates compromises made during an optimization process. A significant hydraulic fracture conductivity increase is possible using large diameter proppants. However, large diameter proppants crush to a greater extent when subjected to high fracture closure stresses, leading to a decrease in the effective hydraulic conductivity of the proppant pack. Further, the larger the proppant particles, the more they are subjected to bridging and trapping in the fracture near the injection point.

A particular proppant is selected based on its ability to resist crushing and provide sufficient fracture conductivity upon being subjected to the fracture closure stress; and its ability to flow deeply into the hydraulic fracture—cost effectively. Proppants are second after water according to volume and mass used during the hydraulic fracturing process. Ceramic proppant has superior beta-factors and more strength compared to sand. However, the cost of ceramic proppants is many fold higher than the cost of sand. Therefore, fracture conductivity improvement requires significant costs for hydraulic fracturing with proppant typically representing 20 to 60 percent of the total for a conventional hydraulic fracturing process.

Apart from the above considerations, there are other proppant characteristics that complicate the production of hydrocarbons. First, formation fluids often bypass a large fraction of the fluid used in the treatment. (The fluid remaining in the proppant pack damages the conductivity of the fracture.) Field studies have shown that the recovery of hydraulic fracturing fluid from fractures in natural gas wells averages only 20 to 50 percent of that injected during the treatments and can be much less. Probably formation fluids flow only along several channels in the form of “fingers” within the proppant pack, or only through that part of the proppant pack near the wellbore during the fracture clean-up process.

The fracture portion containing residual viscous gel hinders fluid flow, thereby reducing effective hydraulic fracture conductivity. Lowering the fracturing fluid viscosity after the treatment is an effective way to increase the fracturing fluid recovery from the proppant pack porosity. The addition of substances called “breakers” promotes gel viscosity reduction. Breakers act by several mechanisms, but most commonly they function by cleaving polymer chains to decrease their length and, thereby, to reduce the polymer solution viscosity. Different breakers are characterized by such parameters as the rate of reaction between the breaker and the polymer, and the activation or deactivation temperatures of the specific breaker in question. Better fracture cleanup can be achieved using high breaker concentrations, but too high a breaker concentration can result in a premature gel viscosity reduction, which may compromise the treatment design and cause premature treatment completion—a screen out. Delayed action breakers, such as encapsulated, were developed to solve this problem. Encapsulated breakers are active breaker chemicals, such as oxidizer granules, coated by protective shells, which isolate the oxidizer from the polymer and delay their reaction. Shell destruction and breaker release take place through various mechanisms, including the action of mechanical stresses occurring at fracture closure. Encapsulated breakers enable higher breaker concentrations to be used in the hydraulic fracturing fluid and, therefore, increase the extent of fracture cleaning

### Breaker

In embodiments, non-surface active substituted ammonium containing aminoacid derivatives, and in particular substituted glycines act as breaker enhancers for fracturing fluids, and may be included in a dual functionality additive composition that contains a surfactant, wherein the inclusion of non-surface active substituted ammonium containing aminoacid derivatives, and in particular substituted glycines depresses the freezing point of the surfactant and additionally acts as a delayed breaker (i.e., reduces the viscosity) for a well treatment fluid (discussed in more detail below).

The purpose of this component is to “break” or diminish the viscosity of the fluid so that this fluid is more easily recovered from the formation during cleanup. Breakers reduce the polymer's molecular weight by the action of an acid, an oxidizer, an enzyme, or some combination of these on the polymer itself.

There are many oilfield applications in which filter cakes are needed in the wellbore, in the near-wellbore region or in one or more strata of the formation. Such applications are those in which, without a filter cake, fluid would leak off into porous rock at an undesirable rate during a well treatment. Such treatments include drilling, drill-in, completion, stimulation (for example, hydraulic fracturing or matrix dissolution), sand control (for example gravel packing, frac-packing, and sand consolidation), diversion, scale control, water control, and others. Typically, after these treatments have been completed the continued presence of the filter cake is undesirable or unacceptable. In such oilfield operations as hydraulic fracturing and gravel packing, viscoelastic surfactant (VES) fluid systems are popular as carrier fluids because of their ability to create a very clean proppant or gravel pack. However, they sometimes experience undesirably high fluid loss, especially when formations with permeabilities greater than about 5 mD are treated. Consequently, fluid loss additives (FLA's) are often used with such carrier fluids to reduce leak off.

There are also many applications in which breakers are needed to decrease the viscosity of treatment fluids, such as fracturing, gravel packing, and acidizing fluids. Most commonly, these breakers act in fluids that are in wellbores or fractures; some breakers can work in fluids in formation pores. Breakers decrease viscosity by degrading polymers or crosslinks when the viscosifiers are polymers or crosslinked polymers. Breakers decrease viscosity by degrading surfactants or changing or destroying micellar structure when viscosifiers are viscoelastic surfactant fluid systems. In embodiments, the application of non-surface active substituted ammonium containing aminoacid derivatives may reduce the viscosity of the treatment. A viscosity reduction of at least about 75% is considered a reasonable break, such as, for example, from about 75% to about 99% and from about 80% to about 95%. For example, the viscosity may be reduced from about 200 cP to about 50 cP, such as reducing the viscosity of a fluid below about 10 cP, as measured at 100s⁻¹ at BHST, such as, from about 100° F. to 325° F. or from about 100° F. to 180° F. Solid, insoluble materials, such as mica, that can be used as proppants in shale gas formation, are typically used in other conventional treatments (these materials may be called fluid loss additives (FLA's), lost circulation additives, and filter cake components). The materials are typically added to fluids used in certain treatments to form filter cakes when they are needed, although sometimes soluble (or at least highly dispersed) components of the treatment fluids themselves (such as polymers or crosslinked polymers) may form the filter cakes, provided that the polymers or crosslinked polymers are too large, or rock pores are too small, to permit entry of much of the polymer or crosslinked polymer. This filter cake is typically formed onto a surface, such as a fracture face. Removal of the filter cake is typically accomplished either by mechanical means (scraping, jetting, or the like), by subsequent addition of a fluid containing an agent (such as an acid, a base, or an enzyme) that dissolves at least a portion of the filter cake, or by manipulation of the physical state of the filter cake (by emulsion inversion, for example). These removal methods usually require a tool or addition of another fluid (for example to change the pH or to add a chemical). This can sometimes be done in the wellbore but normally cannot be done in a proppant or gravel pack. Sometimes the operator may rely on the flow of produced fluids (which will be in the opposite direction from the flow of the fluid when the filter cake was laid down) to loosen the filter cake or to dissolve the filter cake (for example if it is a soluble salt). However, these methods require fluid flow and often result in slow or incomplete filter cake removal. Sometimes a breaker may be incorporated in the filter cake but these must normally be delayed (for example by esterification or encapsulation) and they are often expensive and/or difficult to place and/or difficult to trigger.

There would sometimes be advantages to forming a filter cake inside the pores of a formation. For example, such an “internal” filter cake would not be subject to erosion by fluids flowing across a filter cake that was formed on a wellbore face, a screen, a fracture face, or similar location. Also, an internal filter cake could be more effective at reducing “spurt” the initial fluid loss that occurs as a filter cake is being formed. However, formation of internal filter cakes is usually avoided, since in the past they have been difficult, if not impossible, to remove unless an effective internal breaker is provided.

Additional details regarding breakers are described in U.S. Pat. Nos. 4,715,967 and 6,509,301, and U.S. Patent Application Pub. Nos. 2005/0252659 and 2006/0157248, each of which is incorporated by reference in its entirety.

Non limiting examples of suitable surfactants whose freeze point can be depressed by the non-surface active substituted ammonium containing aminoacid derivatives to create multipurpose additives for breaker compositions include foamers, flow back additives, defoamers, wetting agents, and viscoelastic surfactants which are useful for viscosifying some fluids. Examples of viscoelastic surfactants include cationic surfactants, anionic surfactants, zwitterionic surfactants, amphoteric surfactants, nonionic surfactants, and combinations thereof. Examples of suitable surfactants for the application include ethoxylated linear/branched alcohols, cocamidopropylamine oxide, cocamidopropyl betaine, poly-(oxy-1,2-ethanediyl) nonyl phenol, dicoco dimethyl ammonium chloride, PEO/PPO copolymers, amphoteric alkyl amine, decyl-dimethyl amine oxide, sodium tridecyl ether sulfate, (Z)-13 docosenyl-N—N-bis(2-hydroxyethyl) methyl ammonium chloride, sodium oleate, alkylaryl sulfonate, erucic amidopropyl dimethyl betaine, and the like. Additional surfactants are described in U.S. Pat. No. 6,258,859, the disclosure of which is incorporated by reference herein in its entirety.

One or more additional breakers may also be included. Examples of suitable breakers include peroxysulfuric acid; persulfates such as, for example, ammonium persulfate, sodium persulfate, and potassium persulfate; peroxides such as, for example, hydrogen peroxide, t-butylhydroperoxide, methyl ethyl ketone peroxide, cumene hydroperoxide, benzoyl peroxide, acetone peroxide, methyl ethyl ketone peroxide, 2,2-bis(tert-butylperoxy)butane, pinane hydroperoxide, bis[1-(tert-butylperoxy)-1-methylethyl]benzene, 2,5-bis(tert-butylperoxy)-2,5-dimethylhexane, tert-butyl peroxide, tert-butyl peroxybenzoate, lauroyl peroxide, and dicumyl peroxide; bromates such as sodium bromate and potassium bromate; iodates such as sodium iodate and potassium iodate; periodates such as sodium periodate and potassium periodate; permanganates such as potassium permanganate; chlorites such as sodium chlorite; hyperchlorites such as sodium hyperchlorite; peresters such as tert-butyl peracetate; peracids such as peracetic acid; azo compounds such as azobisisobutyronitrile (AIBN), 2,2′-azobis(2-methylpropionitrile), 1,1′-azobis(cyclohexanecarbonitrile), 4,4′-azobis(4-cyanovaleric acid), and, for example, those sold under the VAZO trade mark by DuPont such as VAZO 52, VAZO 64, VAZO 67, VAZO 88, VAZO 56 WSP, VAZO 56 WSW, and VAZO 68 WSP; perborates such as sodium perborate; percarbonates; and perphosphates. Additional breakers are described in U.S. Pat. No. 8,067,342 and U.S. Pat. No. 7,678,745, the disclosures of which are incorporated by reference herein in their entirety.

The non-surface active substituted ammonium containing aminoacid derivatives may be present in the treatment fluid in amount of from about 0.05% to about 60%, from about 10 wt % to about 55 wt %, such as, for example, from about 10 wt % to about 50 wt % and from about 20 wt % to about 40 wt %, based upon total weight percent of the treatment fluid.

In recent years, fracturing treatments in many low permeability formations in North America were pumped using low viscosity hydraulic fracture fluids that were proppant-free or with only a small amount of proppant. This method has several names, the most common of which is referred to as a waterfrac. Fractures created by the waterfrac process are practically proppant-free. It is anticipated that the created fracture surfaces shift relative to each other during fracture creation and propagation. The resulting misalignment of irregular surface features (asperities) prevents the two fracture faces from forming a tight seal upon closure. Adding a small amount of proppant reportedly intensifies the effect of irregular and misaligned cracked surfaces. However, due to poor transport, the proppant tends to accumulate below the casing perforations, most likely along the base of the created hydraulic fracture. This accumulation occurs due to a high rate of proppant settling in the fracturing fluid along a narrow hydraulic fracture, and insufficient proppant transport ability, (both because of low fracturing fluid viscosity). When fracturing fluid injection stops at the end of a waterfrac, the fracture immediately shortens in length and height. This slightly compacts the proppant, which remains as a “dune” at the fracture base near the wellbore. Because of the dune's limited length, width and, typically, strength (often low-strength sand is used), waterfracs are usually characterized by short, low-conductivity fractures (Experimental Study of Hydraulic Fracture Conductivity Demonstrates the Benefits of Using Proppants, SPE Rocky Mountain Regional/Low-Permeability Reservoirs Symposium and Exhibition, 12-15 March, Denver, Colo., 2000).

The previous discussion illustrates that waterfracs result from the passage of formation fluid flowing through the network of narrow channels created inside of the fracture due to incomplete closure caused by surface rock imperfections, i.e. the waterfrac process results in low conductivity fractures. One method of improving hydraulic fracture conductivity is to construct proppant clusters in the fracture, as opposed constructing a continuous proppant pack. U.S. Pat. No. 6,776,235, the disclosure of which is incorporated by reference herein in its entirety, discloses a method for hydraulically fracturing a subterranean formation involving an initial stage of injecting hydraulic fracturing fluid into a borehole, the fluid containing thickeners to create a fracture in the formation; and alternating stages of periodically introducing into the borehole proppant-containing hydraulic fracturing fluids contrasting in their abilities to transport propping agents and, therefore, contrasting in proppant-settling rates to form proppant clusters as posts that prevent fracture closing. This method alternates the stages of proppant-laden and proppant-free fracturing fluids. The amount of proppant deposited in the fracture during each stage is modulated by varying the fluid transport characteristics (such as viscosity and elasticity), the proppant densities, diameters, and concentrations and the fracturing fluid injection rate.

Additional details regarding the disclosure of hydraulic fracturing fluids are described in U.S. Pat. No. 8,061,424, the disclosure of which is incorporated by reference herein in its entirety.

### Chelating Agent

In embodiments, also described herein is a composition comprised of a non-surface active substituted ammonium containing amino acid derivatives, and in particular substituted glycine or derivatives thereof, such as, for example, the salts of trimethyl glycine hydrate, trimethyl glycine or betaine, or trimethylglycinic acid, or the hydrochloric acid adduct of trimethyl glycine may be used for as ligand for chelating various multivalent cationic species, such as alkali metal ions, alkaline metal earth ions (such as Mg²⁺, Ca²⁺., Sr²⁺, Ba²⁺), or transition metal ions (as referred to by their accepted position on the Periodic Table, (such as Fe²⁺, Mn²⁺, Co²⁺, Fe³⁺, Mn³⁺, Cr³⁺, Co³⁺, and the like).

Chelating agents are materials that are employed, among other uses, to control undesirable reactions of metal ions. In oilfield chemical treatments, chelating agents are frequently added to matrix stimulation acids to prevent precipitation of solids (metal control) as the acids spend on the formation being treated. (See Frenier W. W., et al., “Use of Highly Acid-Soluble Chelating Agents in Well Stimulation Services,” SPE 63242 (2000).) These precipitates include iron hydroxide and iron sulfide. In addition, chelating agents are used as components in many scale removal/prevention formulations. (See Frenier, W. W., “Novel Scale Removers Are Developed for Dissolving Alkaline Earth Deposits,” SPE 65027 (2001).) Two different types of chelating agents are in use: polycarboxylic acids (including aminocarboxylic acids and polyaminopolycarboxylic acids) and phosphonates.

Chelating formulations based on ethylenediaminetetraacetic acid (EDTA) have been used extensively to control iron precipitation and to remove scale. Formulations based on nitrilotriacetic acid (NTA) and diethylenetriaminepentaacetic acid (DTPA) also are in use. Hydroxy chelating agents have also been proposed for use in matrix stimulation of carbonates (see Frenier, et al., “Hydroxyaminocarboxylic Acids Produce Superior Formulations for Matrix Stimulation of Carbonates,” SPE 68924 (2001)) as well as for use as metal control agents and in scale removal fluids. The materials evaluated include hydroxy-aminopolycarboxylic acids (HACA) such as hydroxyethylethylenediaminetriacetic acid (HEDTA) as well as other types of chelating agents.

The non-surface active substituted ammonium containing aminoacid derivatives may act as chelating agents when present in the treatment fluid in amount of from about 0.05% to about 10% or from about 1 wt % to about 5 wt %, based upon total weight percent of the treatment fluid.

### Delayed Crosslinking Agent

One potential oilfield application for a chelating agents is to delay a crosslinking reaction. Disclosed herein are well treatment fluids prepared that comprise non-surface active substituted ammonium containing aminoacid derivatives, and in particular substituted glycines as a delayed crosslinking agent, which can be used to form complexes with the crosslinking metals in aqueous polymer-viscosified systems, and methods to increase the gel cross-linking temperature. Additional details regarding delayed crosslinking agents are described in U.S. Patent Application Pub. No. 2008/0280790, the disclosure of which is incorporated by reference herein in its entirety.

The non-surface active substituted ammonium containing aminoacid derivatives may act as crosslinking delay agents when present in the treatment fluid in amount of from about 0.05% to about 10% or from about 1 wt % to about 5 wt %, based upon total weight percent of the treatment fluid. The non-surface active substituted ammonium containing aminoacid derivatives, and in particular substituted glycines may effectively delay the development of a rheological property of a fluid such as viscosity, yield stress, plastic viscosity, crosslinking time, etc.

High volumes of formation fracturing and other well treatment fluids are commonly thickened with polymers such as guar gum, the viscosity of which is greatly enhanced by crosslinking with a metal such as, for example, chromium aluminum, hathium, antimony, etc., more commonly a Group 4 metal such as zirconium or titanium. In reference to Periodic Table “Groups,” the new IUPAC numbering scheme for the Periodic Table Groups is used as found in HAWLEY′S CONDENSED CHEMICAL DICTIONARY, p. 888 (11th ed. 1987).

Metal-crosslinked polymer fluids can be shear-sensitive after they are crosslinked. In particular, exposure to high shear typically occurs within the tubulars during pumping from the surface to reservoir depth, and can cause an undesired loss of fluid viscosity and resulting problems such as screenout. As used herein, the term “high shear” refers to a shear rate of 500 s⁻¹ or more. The high-shear viscosity loss in metal-crosslinked polymer fluids that can occur during transit down the wellbore to the formation is generally irreversible and cannot be recovered. The term “persistent gels” herein refers to polymers that are crosslinked via a generally irreversible crosslinking mechanism such as, for example, metal crosslinking.

High shear sensitivity of the metal crosslinked fluids can sometimes be addressed by delaying the crosslinking of the fluid so that it is retarded during the high-shear conditions and onset does not occur until the fluid has exited the tubulars. Because the treatment fluid is initially cooler than the formation and is usually heated to the formation temperature only after exiting the tubulars, some delaying agents work by increasing the temperature at which gelation takes place. Bicarbonate and lactate are examples of delaying agents that are known to increase the gelling temperatures of the metal crosslinked polymer fluids. Although these common delaying agents make fluids less sensitive to high shear treatments, they may at the same time result in a decrease in the ultimate fluid viscosity. Also, the common delaying agents may not adequately increase the gelation temperature for the desired delay, especially where the surface fluid mixing temperature is relatively high or the fluid is heated too rapidly during injection.

In some treatment systems, borate crosslinkers have been used in conjunction with metal crosslinkers, such as those described in U.S. Pat. No. 4,780,223, which is incorporated by reference herein in its entirety. In theory, the borate crosslinker can gel the polymer fluid at a low temperature through a reversible crosslinking mechanism that can be broken by exposure to high shear, but can repair or heal after the high shear condition is removed. The shear-healing borate crosslinker can then be used to thicken the fluid during high shear such as injection through the wellbore while the irreversible metal crosslinking is delayed until the high shear condition is passed. A high pH, e.g. 9 to 12 or more, is usually used to effect borate crosslinking, and in some instances as a means to control the borate crosslinking. For example, the pH and/or the borate concentration may be adjusted on the fly in response to pressure friction readings during the injection so that the borate crosslinking occurs near the exit from the tubulars in the wellbore. The metal crosslinker must of course be suitable for use at these pH conditions and must not excessively interfere with the borate crosslinking.

Some aspects of the current disclosure are directed to methods of treating subterranean formations using an aqueous mixture of a polymer that is crosslinked with a metal-ligand complex. The hydratable polymer is generally stable in the presence of dissolved salts. Accordingly, ordinary tap water, produced water, brines, and the like can be used to prepare the polymer solution used in an embodiment of the aqueous mixture.

In embodiments where the aqueous medium is a brine, the brine is water comprising an inorganic salt or organic salt. Some useful inorganic salts include, but are not limited to, alkali metal halides, such as potassium chloride. The carrier brine phase may also comprise an organic salt, preferably sodium or potassium formate. Some inorganic divalent salts include calcium halides, such as calcium chloride or calcium bromide. Sodium bromide, potassium bromide, or cesium bromide may also be used. The salt is chosen for compatibility reasons i.e., where the reservoir drilling fluid used a particular brine phase and the completion/clean up fluid brine phase is chosen to have the same brine phase. Some salts can also function as stabilizers, e.g. clay stabilizers such as KCl or tetramethyl ammonium chloride, TMAC, and/or charge screening of ionic polymers.

The hydratable polymer may be a high molecular weight water-soluble polysaccharide containing cis-hydroxyl and/or carboxylate groups that can form a complex with the released metal. Without limitation, useful polysaccharides have molecular weights in the range of about 200,000 to about 3,000,000. Galactomannans represent an embodiment of polysaccharides having adjacent cis-hydroxyl groups for the purposes herein. The term galactomannans refers in various aspects to natural occurring polysaccharides derived from various endosperms of seeds. They are primarily composed of D-mannose and D-galactose units. They generally have similar physical properties, such as being soluble in water to form thick highly viscous solutions which usually can be gelled (crosslinked) by the addition of such inorganic salts as borax. Examples of some plants producing seeds containing galactomannan gums include tara, huisache, locust bean, palo verde, flame tree, guar bean plant, honey locust, lucerne, Kentucky coffee bean, Japanese pagoda tree, indigo, jenna, rattlehox, clover, fenergruk seeds, soy bean hulls and the like. The gum is provided in a convenient particulate form. Of these polysaccharides, guar and its derivatives are preferred. These include guar gum, carboxymethyl guar, hydroxyethyl guar, carboxymethylhydroxyethyl guar, hydroxypropyl guar (HPG), carboxymethylhydroxypropyl guar (CMHPG), guar hydroxyalkyltriammonium chloride, and combinations thereof. As a galactomannan, guar gum is a branched copolymer containing a mannose backbone with galactose branches.

Heteropolysaccharides, such as diutan, xanthan, diutan mixture with any other polymers, and scleroglucan may be used as the hydratable polymer. Synthetic polymers such as, but not limited to, polyacrylamide and polyacrylate polymers and copolymers are used typically for high-temperature applications. Non-limiting examples of suitable viscoelastic surfactants useful for viscosifying some fluids include cationic surfactants, anionic surfactants, zwitterionic surfactants, amphoteric surfactants, nonionic surfactants, and combinations thereof.

The hydratable polymer may be present at any suitable concentration. In various embodiments hereof, the hydratable polymer can be present in an amount of from about 1.2 to less than about 7.2 g/L (10 to 60 pounds per thousand gallons or ppt) of liquid phase, or from about 15 to less than about 40 pounds per thousand gallons, from about 1.8 g/L (15 ppt) to about 4.2 g/L (35 ppt), 1.8 g/L (15 ppt) to about 3 g/L (25 ppt), or even from about 2 g/L (17 ppt) to about 2.6 g/L (22 ppt). Generally, the hydratable polymer can be present in an amount of from about 1.2 g/L (10 ppt) to less than about 6 g/L (50 ppt) of liquid phase, with a lower limit of polymer being no less than about 1.2, 1.32, 1.44, 1.56, 1.68, 1.8, 1.92, 2.04, 2.16 or 2.18 g/L (10, 11, 12, 13, 14, 15, 16, 17, 18, or 19 ppt) of the liquid phase, and the upper limit being less than about 7.2 g/L (60 ppt), no greater than 7.07, 6.47, 5.87, 5.27, 4.67, 4.07, 3.6, 3.47, 3.36, 3.24, 3.12, 3, 2.88, 2.76, 2.64, 2.52, or 2.4 g/L (59, 54, 49, 44, 39, 34, 30, 29, 28, 27, 26, 25, 24, 23, 22, 21, or 20 ppt) of the liquid phase. In some embodiments, the polymers can be present in an amount of about 2.4 g/L (20 ppt).

Fluids incorporating a hydratable polymer may have any suitable viscosity, preferably a viscosity value of about 50 mPa-s or greater at a shear rate of about 100 s⁻¹ at treatment temperature, more preferably about 75 mPa-s or greater at a shear rate of about 100 s⁻¹, and even more preferably about 100 mPa-s or greater, in some instances. At the concentrations mentioned, the hydration rate is independent of guar concentration. Use of lower levels tends to lead to development of insufficient viscosity, while higher concentrations tend to waste material. Where those disadvantages are avoided, higher and lower concentrations are useful.

### Additional Materials

In embodiments, the fluid may further comprise stabilizing agents, surfactants, diverting agents, or other additives. Additionally, the treatment fluid may comprise a mixture various other crosslinking agents, and/or other additives, such as fibers or fillers, provided that the other components chosen for the mixture are compatible with the intended use of forming a crosslinked three dimensional structure that at least partially seals a portion of a subterranean formation, such as a water bearing portion of a subterranean formation, permeated by the treatment fluid or treatment fluid. In embodiments, the treatment fluids of the present disclosure may further comprise one or more components selected from the group consisting of a gel breaker, a buffer, a proppant, a clay stabilizer, a gel stabilizer, and a bactericide. Furthermore, the treatment fluid or treatment fluid may comprise buffers, pH control agents, and various other additives added to promote the stability or the functionality of the fluid. The treatment fluid or treatment fluid may be based on an aqueous or non-aqueous solution. The components of the treatment fluid or treatment fluid may be selected such that they may or may not react with the subterranean formation that is to be treated.

A buffering agent may be employed to buffer the fracturing fluid, i.e., moderate amounts of either a strong base or acid may be added without causing any large change in pH value of the fracturing fluid. In various embodiments, the buffering agent is a combination of: a weak acid and a salt of the weak acid; an acid salt with a normal salt; or two acid salts. Examples of suitable buffering agents are: NaH₂PO₄—Na₂HPO₄; sodium carbonate-sodium bicarbonate; sodium bicarbonate; and the like. By employing a buffering agent in addition to a hydroxyl ion producing material, a fracturing fluid is provided which is more stable to a wide range of pH values found in local water supplies and to the influence of acidic materials located in formations and the like. In an exemplary embodiment, the pH control agent is varied between about 0.6 percent and about 40 percent by weight of the polysaccharide employed.

Non-limiting examples of hydroxyl ion producing materials include any soluble or partially soluble hydroxide or carbonate that provides the desirable pH value in the fracturing fluid to promote borate ion formation and crosslinking with the polysaccharide and polyol. The alkali metal hydroxides, e.g., sodium hydroxide, and carbonates are preferred. Other acceptable materials are calcium hydroxide, magnesium hydroxide, bismuth hydroxide, lead hydroxide, nickel hydroxide, barium hydroxide, strontium hydroxide, and the like. At temperatures above about 79° C. (175° F.), potassium fluoride (KF) can be used to prevent the precipitation of MgO (magnesium oxide) when magnesium hydroxide is used as a hydroxyl ion releasing agent. The amount of the hydroxyl ion releasing agent used in an embodiment is sufficient to yield a pH value in the fracturing fluid of at least about 8.0, preferably at least 8.5, preferably at least about 9.5, and more preferably between about 9.5 and about 12.

Aqueous fluid embodiments may also comprise an organoamino compound. Examples of suitable organoamino compounds include, but are not necessarily limited to, tetraethylenepentamine (TEPA), triethylenetetramine, pentaethylenhexamine, triethanolamine (TEA), and the like, or any mixtures thereof. A particularly useful organoamino compound is TEPA. Organoamines may be used to adjust (increase) pH, for example. When organoamino compounds are used in fluids, they are incorporated at an amount from about 0.01 weight percent to about 2.0 weight percent based on total liquid phase weight. Preferably, when used, the organoamino compound is incorporated at an amount from about 0.05 weight percent to about 1.0 weight percent based on total liquid phase weight.

A borate source can be used as a co-crosslinker, especially where low temperature, reversible crosslinking is used in the method for generally continuous viscosification before the polymer is crosslinked with the metal-ligand complex, or simultaneously. The aqueous mixture can thus include a borate source (also referred to as a borate slurry), which can either be included as a soluble borate or borate precursor such as boric acid, or it can be provided as a slurry of borate source solids for delayed borate crosslinking until the fluid is near exit from the tubular into the downhole formation. By definition, “slurry” is a mixture of suspended solids and liquids. The slurry that is used in at least some embodiments can be prepared at or near the site of the well bore or can be prepared at a remote location and shipped to the well site. Methods of preparing slurries are known in the art. In embodiments, the slurry may be prepared offsite, since this can reduce the expense associated with the transport of equipment and materials.

In some embodiments, ionic polymers (such as CMHPG) in an aqueous solution can be present in solvated coils that have a larger radius of gyration than the corresponding non-ionic parent polymer due to electric repulsions between like charges from the ionic substituents. This may cause the polymer to spread out without sufficient overlapping of the functional groups from different polymer chains for a crosslinker to react with more than one functional group (no crosslinking), or alternatively, it may cause the orientation of functional groups to exist in an orientation that is difficult for the crosslinker to reach. For example, in deionized water, guar polymer can be crosslinked easily by boron crosslinker while CMHPG can not. Screening the charges of the ionic species can reduce or eliminate the electric repulsion and thus collapse the polymer coil to create some overlapping, which in turn can allow the crosslinker to crosslink the ionic polymers.

Charge screening surfactants may be employed. Different compounds to screen the charges of an ionic polymer (for example CMHPG), namely KCl (or other salt to increase ionic strength) to screen, or ionic surfactants to screen, such as quaternary ammonium salt for CMHPG, may be used. Salts can be selected from a group of different common salts including organic or inorganic such as KCl, NaCl, NaBr, CaCl₂, R₄N⁺Cl⁻ (e.g. TMAC), NaOAc etc. Surfactants can be fatty acid quaternary amine chloride (bromide, iodide), with at least one alkyl group being long chain fatty acid or alpha olefin derivatives, other substituents can be methyl, ethyl, iso-propyl type of alkyls, ethoxylated alkyl, aromatic alkyls etc. Some methods may also use cationic polymers. The non-surface active substituted ammonium containing aminoacid derivatives, and in particular substituted glycines may be used as an environmentally compatible ionic polymer charge screening compounds for the purpose of enhanced crosslinking ability and improved viscosity yield.

Although not limited to any particular theory of operation or mechanism, it is conceptualized that fluid performance may be further optimized when polymer coils in solution and have enough overlapping so that crosslinking occurs both intra- and inter-molecularly. Viscoelasticity improvements may come from inter-molecular crosslink, and intra-molecular crosslink cannot be effectively avoided. For example, adding KCl or tetramethylammonium chloride (TMAC) to an anionic polymer solution such as CMHPG can effectively screen the anionic charges with electric bi-layers to decrease the charge intensity, and in turn decrease the repulsions between charged polymer chains. Charge screening in this manner can collapse the polymer chains and achieve overlapping for crosslinking to occur. The use of non-surface active substituted ammonium containing aminoacid derivatives, and in particular substituted glycines in fracturing fluids may provide a more environmentally friendly additive for this purpose of charge screening.

Charged compounds might also participate in charge screening processes resulting in enhanced or decreased micellar length growth for Viscoelastic surfactant mixtures forming worm like micelles. As such, the non-surface active substituted ammonium containing aminoacid derivatives, and in particular substituted glycines may act as monomeric friction reduction enhancers such as those described in U.S. Patent Application Pub. No. 2008/0064614 which is incorporated by reference herein in its entirety.

Some fluids according to some embodiments may also include a surfactant. In one embodiment, for example, the aqueous mixture comprises both a stabilizer such as KCl or especially TMAC, as well as a charge screening surfactant. This system can be particularly effective in ligand-metal crosslinker methods that also employ borate as a low temperature co-crosslinker. Alternatively or additionally, any surfactant which aids the dispersion and/or stabilization of a gas component in the base fluid to form an energized fluid can be used. Viscoelastic surfactants, such as those described in U.S. Pat. No. 6,703,352, U.S. Pat. No. 6,239,183, U.S. Pat. No. 6,506,710, U.S. Pat. No. 7,303,018 and U.S. Pat. No. 6,482,866, all incorporated herein by reference in their entireties, are also suitable for use in fluids in some embodiments. Examples of suitable surfactants also include, but are not limited to, amphoteric surfactants or zwitterionic surfactants. Alkyl betaines, alkyl amido betaines, alkyl imidazolines, alkyl amine oxides and alkyl quaternary ammonium carboxylates are some examples of zwitterionic surfactants. An example of a useful surfactant is the amphoteric alkyl amine contained in the surfactant solution AQUAT 944® (available from Baker Petrolite of Sugar Land, Tex.).

Charge screening surfactants may be employed, as previously mentioned. In some embodiments, the anionic surfactants such as alkyl carboxylates, alkyl ether carboxylates, alkyl sulfates, alkyl ether sulfates, alkyl sulfonates, α-olefin sulfonates, alkyl ether sulfates, alkyl phosphates and alkyl ether phosphates may be used. Anionic surfactants typically have a negatively charged moiety and a hydrophobic or aliphatic tail, and can be used to charge screen cationic polymers. Examples of suitable ionic surfactants also include, but are not limited to, cationic surfactants such as alkyl amines, alkyl diamines, alkyl ether amines, alkyl quaternary ammonium, dialkyl quaternary ammonium and ester quaternary ammonium compounds. Cationic surfactants typically have a positively charged moiety and a hydrophobic or aliphatic tail, and can be used to charge screen anionic polymers such as CMHPG.

In other embodiments, the surfactant is a blend of two or more of the surfactants described above, or a blend of any of the surfactant or surfactants described above with one or more nonionic surfactants. Examples of suitable nonionic surfactants include, but are not limited to, alkyl alcohol ethoxylates, alkyl phenol ethoxylates, alkyl acid ethoxylates, alkyl amine ethoxylates, sorbitan alkanoates and ethoxylated sorbitan alkanoates. Any effective amount of surfactant or blend of surfactants may be used in aqueous energized fluids. Preferably the fluids incorporate the surfactant or blend of surfactants in an amount of about 0.02 weight percent to about 5 weight percent of total liquid phase weight, and more preferably from about 0.05 weight percent to about 2 weight percent of total liquid phase weight. One particularly useful surfactant is sodium tridecyl ether sulfate.

Friction reducers may also be incorporated in any fluid embodiment. Any suitable friction reducer polymer, such as polyacrylamide and copolymers, partially hydrolyzed polyacrylamide, poly(2-acrylamido-2-methyl-1-propane sulfonic acid) (polyAMPS), and polyethylene oxide may be used. Commercial drag reducing chemicals such as those sold by Conoco Inc. under the trademark “CDR” as described in U.S. Pat. No. 3,692,676 or drag reducers such as those sold by Chemlink designated under the trademarks FLO1003, FLO1004, FLO1005 and FLO1008 have also been found to be effective. These polymeric species added as friction reducers or viscosity index improvers may also act as excellent fluid loss additives reducing or even eliminating the need for conventional fluid loss additives. Latex resins or polymer emulsions may be incorporated as fluid loss additives. Shear recovery agents may also be used in embodiments.

The fluids and/or methods may be used for hydraulically fracturing a subterranean formation. Techniques for hydraulically fracturing a subterranean formation are known to persons of ordinary skill in the art, and involve pumping a fracturing fluid into the borehole and out into the surrounding formation. The fluid pressure is above the minimum in situ rock stress, thus creating or extending fractures in the formation. See Stimulation Engineering Handbook, John W. Ely, Pennwell Publishing Co., Tulsa, Okla. (1994), U.S. Pat. No. 5,551,516 (Normal et al.), “Oilfield Applications,” Encyclopedia of Polymer Science and Engineering, vol. 10, pp. 328-366 (John Wiley & Sons, Inc. New York, N.Y., 1987) and references cited therein.

In various embodiments, hydraulic fracturing involves pumping a proppant-free viscous fluid, or pad—usually water with some fluid additives to generate high viscosity—into a well faster than the fluid can escape into the formation so that the pressure rises and the rock breaks, creating artificial fractures and/or enlarging existing fractures. Then, proppant particles are added to the fluid to form slurry that is pumped into the fracture to prevent it from closing when the pumping pressure is released. In the fracturing treatment, fluids of are used in the pad treatment, the proppant stage, or both.

### Corrosion Inhibitor

In another embodiment, non-surface active substituted ammonium containing aminoacid derivatives, and in particular substituted glycines may be used as an environmentally friendly corrosion inhibitor that effectively protects various tools employed in oilfield operations by surface treating these tools with TMG. Examples of potential tools include coil tubing pipe, wireline cables and assemblies, slick line cables and assemblies, casing, drill pipe and the like

Acid is employed in a multitude of operations in the oil and chemical industry. Metal surfaces exposed to acidic treatment fluids include piping and tubing used in industrial chemical equipment such as, for example, in heat exchangers and reactors. Acidic treatment fluids are also often used as a treating fluid in wells penetrating subterranean formations. Such acidic treatment fluids may include, for example, acidic clean-up fluids or stimulation fluids for oil and gas wells. Acidic stimulation fluids may include, for example, fluids used in hydraulic fracturing and matrix acidizing treatments.

Acidic treatment fluids may include a variety of acids such as, for example, hydrochloric acid, formic acid, hydrofluoric acid, and the like. While acidic treatment fluids may be useful for a variety of downhole operations, acidic treatment fluids can be problematic in that they can cause corrosion to downhole production tubing and downhole tools.

A corrosion inhibitor system that is free or substantially free of any short-chain aliphatic acids, such as formic acid, as described previously, is used with the acid treatment fluid. As used herein, the expression “corrosion inhibitor system” is meant to encompass both the active corrosion inhibitor components as well as any non-active components, such as solvents, dispersing agents, etc., which may be in solution or premixed together prior to combining with the treatment fluid. In certain instances, the corrosion inhibitor system may include only active components. The corrosion inhibitor system is typically provided in liquid form and is mixed with the other components of the treatment fluid at the surface and then introduced into the formation. The corrosion inhibitor system is present in the treatment fluid in an amount of from about 0.2% to about 3% by total weight of the treatment fluid. The corrosion inhibitor used with the fluids of the present invention includes an alkyl, alkenyl, alycyclic or aromatic substituted aliphatic ketone, which includes alkenyl phenones, or an aliphatic or aromatic aldehyde, which includes .alpha, or beta.-unsaturated aldehydes, or a combination of these. Alkyl, alycyclic or aromatic phenone and aromatic aldehyde compounds may also be used in certain applications. Other unsaturated ketones or unsaturated aldehydes may also be used. Alkynol phenone, aromatic and acetylenic alcohols and quaternary ammonia compounds, and mixtures of these may be used, as well. All of these may be dispersed in a suitable solvent, such as an alcohol, and may further include a dispersing agent and other additives.

The active corrosion inhibitor components may be dispersed in a solvent. The solvent useable in the formulation may be a non-aqueous organic liquid selected from polar aprotic solvents, aromatic solvents, terpinols, and alcohols. Examples of suitable solvents include polar aprotic dimethyl formamide (DMF), dimethylsulfoxide (DMSO), dimethylacetamide (DMA), 1-methyl-2-pyrrolidone (“pyrrolidone”), tetramethylene sulfone (“sulfolane”), and mixtures thereof. The aprotic solvent (e.g. DMF, DMSO, DMA, pyrrolidone, and sulfolane) may be blended with alcohol and/or aromatic solvents. The aromatic solvents include heavy aromatic naptha, xylene, toluene, and others as described in U.S. Pat. No. 4,498,997, which is incorporated herein by reference. Examples of suitable alcohol solvents include ethanol, propanol, isopropanol, n-butanol, isobutanol, ethylene glycol, diethylene glycol, monobutyl ether of ethylene glycol, glycerine and the like. Propargyl alcohol may also be used. The alcohol solvent may make up from about 0.1% to about 99.99% by total weight of the corrosion inhibitor system.

Additional materials such as the halide salts or surfactants described above may be included in the corrosion inhibitor composition. Furthermore, additional details regarding corrosion inhibitor are described in U.S. Patent Application Pub. No. 2010/0056405, which is incorporated by reference herein in its entirety.

The non-surface active substituted ammonium containing aminoacid derivatives may act as corrosion inhibitor when present in the treatment fluid in amount of from about 0.5% to about 10% or from about 1 wt % to about 5 wt %, based upon total weight percent of the treatment fluid, depending on the metal composition, and the acid strength.

### Freezing Point Reducer

In another embodiment, non-surface active substituted ammonium containing aminoacid derivatives, and in particular substituted glycines may be used as an additive to depress the freezing point of any of the fluids used in the oilfield industry. These materials may be used instead of the conventional “non-green” freezing point depressing materials, such as ethylene glycols, polypropylene glycols, isopropanol, ethanol or methanol and derivatives thereof. Specific fluids include pumpable fluids such as, for example, fracturing fluids, sand control fluids, water control fluids, spacers, drilling fluids, well control pills, acid stimulation treatment fluids, loss circulation pills and the like, as well as additives used to formulate fluids used in one or more oilfield processes, such as fracturing, cementing, sand control, shale stabilization, fines migration, drilling fluid, friction pressure reduction, and other known formulation fluids, including but not limited to crosslinkers, surfactants, gelling agent slurries, H₂S scavengers, high temperature stabilizers, delay agents, scale inhibitors, sludge prevention additives, scale dissolvers, gas hydrated inhibitors, wax inhibitors, asphaltene inhibitors, defoamers, activators, buffers, breaker solutions, chelating agents, corrosion inhibitors, biocides, foamers, flow back additives, retarders, dispersant, fines migration additives, and the like.

If the treatment fluid is employed to treat loss circulation, fluid may contain a loss circulation material. Examples include fly ash, a silica compound, a fluid loss control additive, an emulsion, latex, a dispersant, an accelerator, a retarder, a salt, mica, sand, a fiber, a formation containing agent, fumed silica, bentonite, a microsphere, a carbonate, barite, hematite, an epoxy resin and a curing agent.

U.S. Pat. No. 6,294,104, the disclosure of which is incorporated by reference herein in its entirety, describes liquid compositions to prevent the freezing of aircraft and runways, wherein the liquid compositions described therein are environmentally friendly liquids suitable for various spraying equipment.

For example, non-surface active substituted ammonium containing aminoacid derivatives, and in particular substituted glycines may be added to aqueous formulations of chemical additives that are commonly used in the oilfield industry. Because some of these chemical additives are liquids prone to become solids or highly viscous at low temperatures or are typically solids at ambient temperatures, they can be un-meterable using a suitable type of liquid additive device, such as piston pumps, diaphragm pumps, and mass flow meters. The non-surface active substituted ammonium containing aminoacid derivatives, and in particular substituted glycines may be used as an environmentally friendly additive to reduce the freezing points, and enhance the pumpability of chemical additives that are used in the oilfield, such as crosslinkers, surfactants, gelling agent slurries, H₂S scavengers, high temperature stabilizers, delay agents, scale inhibitors, sludge prevention additives, scale dissolvers, gas hydrated inhibitors, wax inhibitors, asphaltene inhibitors, defoamers, activators, buffers, breaker solutions, chelating agents, corrosion inhibitors, biocides, foamers, flow back additives, retarders, dispersant, fines migration additives, and the like. Examples of each of these chemical additives are described in U.S. Pat. Nos. 7,968,501 B2, 6,720,290 B2, 7,998,909 B2, 7,950,462 B2, 4,734,259 A, the disclosures of which are incorporated by reference herein in their entirety.

The non-surface active substituted ammonium containing aminoacid derivatives, and in particular substituted glycines are non flammable, and thus may be used as an environmentally friendly additive to reduce the freezing points, and reduce additive flammability of chemical additives that are used in the oilfield, such as surfactants, crosslinkers, activators, biocides, flow back additives, scale inhibitors, corrosion inhibitors, dispersant, fines migration additives, and the like.

In the oilfield industry, it is necessary to formulate stimulation, cementing, sand control, drilling fluids, to be functional in environments where the ambient temperature is about 0° C. At these conditions, several of the chemical additives commonly used in the oilfield may freeze, reach their kraft point, or become highly viscous, all of which are processes that render the materials un-pumpable and/or un-meterable without specially designed tools. In these cases, it may be necessary to use environmentally unfriendly chemicals, such as methanol, isopropanol, ethylene glycol, propylene glycol, glycerol, and the like to reduce the freezing point of the additive, to maintain the viscosity so that the aqueous fluid that can be metered and/or pumped. However, as discussed above, several of these chemical additives, have low boiling and flash points, rendering the chemicals additives flammable, and hence more intrinsically unsafe as their handling and transport inevitably requires additional safety considerations. Furthermore, these traditional freezing point depressants, such as alcohols, may also damage the fluid formulation, as these chemicals can pose conflicting performances with fracturing, sand control, or cement formulations with respect to gelling, crosslinking, breaking, and their respective delay, acceleration, enhancement, promotion, reduction or suppression.

With regards to hydraulic fracturing, in cold climates fracturing requires maintaining the carrier liquid fluid so that the liquid is capable of hydrating the polymer. One option is to mix water with an amount of methanol, such as, for example, up to about 30% weight methanol to depress the fluid freezing point. Because methanol is a precipitant for some lower cost polymers often used in hydraulic fracturing, such as guar, the polymer cannot be dissolved in water-methanol mixtures, and thus methanol is not typically used (or used at all) to depress a fluid's freezing point. To address this issue, a methanol tolerant guar derivative, such as, for example, hydroxy propyl guar may be used. However, hydroxyl propyl guar is more expensive and can yield a lower viscosity than native guar, as it is less easily crosslinked with borate than guar. Methanol can also be problematic because it is a flammable material even at low temperatures and/or pressures, and thus poses a potential danger to both people and the environment.

In one embodiment non-surface active substituted ammonium containing aminoacid derivatives, and in particular substituted glycines, and more in particular TMG may be used as an additive to depress the freezing point of fracturing fluids to be pumped in conditions where the ambient temperature is low in fluids viscosified by the natural raw guar gum. Currently in such conditions water and methanol mixtures are used in combination with the expensive derivatized guar gum products like HPG, since methanol and guar gum are not effectively compatible.

The non-surface active substituted ammonium containing aminoacid derivatives may act as freezing point depressant when present in the additive in amount of from about 5% to about 70% or from about 10 wt % to about 50 wt %, based upon total weight percent of the additive. The non-surface active substituted ammonium containing aminoacid derivatives may act as freezing point depressant for the fluid when present in the treatment fluid in amount of from about 5% to about 20% or from about 10 wt % to about 20 wt %, based upon total weight percent of the treatment fluid.

Gas Hydrate Inhibitor

In another embodiment, non-surface active substituted ammonium containing aminoacid derivatives, and in particular substituted glycines, and more in particular trimethyl glycine may be used as an environmentally friendly hydrate inhibitor that effectively prevents the formation of water and methane hydrates or clathrates

Clathrate hydrates (or gas clathrates, gas hydrates, clathrates, hydrates, etc.) are crystalline water-based solids physically resembling ice, in which small non-polar molecules (typically gases) or polar molecules with large hydrophobic moieties are trapped inside “cages” of hydrogen bonded water molecules. In other words, clathrate hydrates are clathrate compounds in which the host molecule is water and the guest molecule is typically a gas or liquid. Without the support of the trapped molecules, the lattice structure of hydrate clathrates would collapse into conventional ice crystal structure or liquid water. Most low molecular weight gases (including O₂, H₂, N₂, CO₂, CH₄, H₂S, Ar, Kr, and Xe), as well as some higher hydrocarbons and freons will form hydrates at suitable temperatures and pressures. Clathrate hydrates are not chemical compounds as the sequestered molecules are never bonded to the lattice. The formation and decomposition of clathrate hydrates are first order phase transitions, not chemical reactions.

Clathrates have been found to occur naturally in large quantities. Around 6.4 trillion (i.e. 6.4×10¹²) tonnes of methane is trapped in deposits of methane clathrate on the deep ocean floor. Such deposits can be found on the Norwegian continental shelf in the northern headwall flank of the Storegga Slide. Clathrates can also exist as permafrost, as at the Mallik gas hydrate field in the Mackenzie Delta of northwestern Canadian Arctic. These natural gas hydrates are seen as a potentially vast energy resource, but an economical extraction method has so far proven elusive.

Gas hydrates or clathrates can form in pipelines, formations, fractures and wellbores. Thermodynamic conditions favoring hydrate formation are often found in oilfield operation conditions where water, gas and low temperatures are combined. This is highly undesirable because the clathrate crystals might agglomerate and plug the flowline and cause flow assurance, reduce natural permeability and or cause failure and damage to valves and instrumentation. The results can range from flow reduction to equipment damage.

Hydrate formation, prevention and mitigation are therefore a long sought after oilfield chemistry target. Hydrates have a strong tendency to agglomerate and to adhere to the pipe wall and thereby plug the pipeline. Once formed, they can be decomposed by increasing the temperature and/or decreasing the pressure. Even under these conditions, the hydrate dissociation may be a slow process.

The non-surface active substituted ammonium containing aminoacid derivatives can be injected in hydrate prone wellbore or pipes where they may act as freezing point depressant when present in the fluid in amount of from about 5% to about 70% or from about 20 wt % to about 50 wt %, based upon total weight percent of the treatment.

### Fluid Loss Enhancement

Non-surface active substituted ammonium containing aminoacid derivatives, and in particular substituted glycine may also be used as an environmentally compatible particle suspending agent and a fluid loss reducer in conjunction with various particles. In embodiments, a fluid loss reducing agent or particle suspending agent comprised of at least one non-surface active substituted ammonium containing aminoacid derivatives, and in particular substituted glycine when used in conjunction with a traditional fluid loss additive may enhance the fluid loss reducing agent's particle suspension ability. The fluid loss reducing agent and/or the particle suspending agent may be used in various subterranean treatment processes, such as, for example, fracturing, gravel packing, cementing, drilling fluid and any other fluid used for subterranean treatment. Further, examples of the particles that are capable of being suspended include the particles that various carbonates, such as calcium carbonate and magnesium carbonate, mica, latex, sand, polymer beads and platelets, barite, clays, weighting agents, cement, proppant, and the like.

Hydraulic fracturing of oil or gas wells is a technique routinely used to improve or stimulate the recovery of hydrocarbons. In such wells, hydraulic fracturing is usually accomplished by introducing a proppant-laden treatment fluid into a producing interval at high pressures and at high rates sufficient to crack the rock open. This fluid induces a fracture in the reservoir as it leaks off in the surrounding formation and transports proppant into the fracture. After the treatment, proppant remains in the fracture in the form of a permeable and porous proppant pack that serves to maintain the fracture open as hydrocarbons are produced. In this way, the proppant pack forms a highly conductive pathway for hydrocarbons and/or other formation fluids to flow into the wellbore.

Typically, viscous fluids or foams are employed as fracturing fluids in order to provide a medium that will have sufficient viscosity to crack the rock open, adequately suspend and transport solid proppant materials, as well as decrease loss of fracture fluid to the formation during treatment (commonly referred to as “fluid loss”). While a reduced fluid loss allows for a better efficiency of the treatment, a higher fluid loss corresponds to fluids “wasted” in the reservoir, and implies a more expensive treatment. Also, it is known that the degree of fluid loss can significantly depend upon formation permeability. Furthermore fluid efficiency of a fracture fluid may affect fracture geometry, since the viscosity of the fluid might change as the fluid is lost in the formation. This is the case for polymer-based fracturing fluids that concentrate in lower permeability formations as the fracture propagates due to leak off of the water in the formation, while the polymer molecules remain in the fracture by simple size exclusion from the pores of the reservoir. The fluid in the fracture increases in viscosity as the fracture propagates and the fracture generated will also increase in width as well as in length. In the case of viscoelastic surfactant (VES) based fluids, the fracturing fluid does not concentrate since the fracturing fluid is lost in the formation and typically the fractures generated are long and very narrow. Hence, fluid efficiency affects fracture geometry.

For VES based fluids, excessive fluid loss results in fractures that are narrower than desired. Also, excessive fluid loss may translate into significant job size where hundreds of thousands of additional gallons of water may be pumped to generate the required length of fracture and overcome low fluid efficiency. Fracturing fluids should have a minimal leak-off rate to avoid fluid migration into the formation rocks and minimize the damage that the fracturing fluid or the water leaking off does to the formation. Also the fluid loss should be minimized such that the fracturing fluid remains in the fracture and can be more easily degraded, so as not to leave residual material that may prevent hydrocarbons to flow into the wellbore.

Early fracturing fluids were constituted of viscous or gelled oil but, with the understanding that formation damage due to water may not be as important as originally thought, aqueous fracturing fluids mainly consisting of “linear” polymeric gels comprising guar, derivatized guar, cellulose, or derivatized cellulose were introduced. In order to attain a sufficient fluid viscosity and thermal stability in high temperature reservoirs, linear polymer gels were partially replaced by cross-linked polymer gels such as those based on guar crosslinked with borate or polymers crosslinked with metallic ions. However, as it became apparent that crosslinked polymer gel residues might not degrade completely and leave a proppant pack with an impaired retained conductivity, fluids with lower polymer content were introduced. In addition, some additives were introduced to improve the cleanup of polymer-based fracturing fluids. These included polymer breakers. Nonetheless the polymer based fracturing treatments leave proppant pack with damaged retained conductivity since the polymer fluids concentrate in the fracture while the water leaks off in the reservoir that may impair the production of hydrocarbons from the reservoir.

Based on reservoir simulations and field data, it is commonly observed that production resulting from a fracturing treatment is often lower than expected. This phenomenon is particularly the case in tight gas formations. Indeed, production can be decreased significantly by concentrated polymer left in the fracture due to leak off of the fracturing fluid during treatment. Filter cakes may result in poor proppant pack cleanup due to the yield stress properties of the fluid. This may happen when a crosslinked polymer based fluid is pumped that leaks off into the matrix and becomes concentrated, and extremely difficult to remove. Breaker effectiveness may thus become reduced, and viscous fingering inside the proppant pack may occur which further results in poor cleanup. Furthermore, the filter cake yield stress created by the leak off process can occlude the fracture width and restrict fluid flow, resulting in a reduction in the effective fracture half-length.

Accordingly, there is a need for methods for treating subterranean formations using fluids which enable efficient pumping, which significantly decrease and control the leak off relative to conventional fracturing treatments in order to reduce the damage to the production, while having good cleanup properties as well as improved fluid efficiency (i.e. providing less expensive and time-consuming treatment). These needs are met, at least in part, with the subject matter described herein.

For instance, a large number of clays could be included in the above composition as fluid loss additives. It has been found that non-surface active substituted ammonium containing aminoacid derivatives, and in particular substituted glycine when used in conjunction with clays may enhance the fluid loss reducing agent's particle suspension ability. As defined herein and known in the art the term “clay” is defined as a group of hydrous aluminum phyllosilicates minerals that are generally less than 2 μm in diameter that consist of a variety of phyllosilicate minerals rich in various silicon and aluminum oxides and hydroxides in addition to variable amounts of structural water. Suitable examples of clays include kaolinite clays, montmorillonite-smectite clays, illite clays, chlorite clays and synthetic clays such as Laponite. Additional examples of clays include various types of “pure” or “natural clays”. For example, montmorillonite clay has a chemical formula of (Na, Ca)_{0.33}(Al,Mg)₂Si₄O₁₀(OH)₂nH₂O.

The non-surface active substituted ammonium containing aminoacid derivatives may act as environmentally friendly particle suspending agent and fluid loss reducer when present in the fluid in amount of from about 1% to about 30% or from about 2 wt % to about 10 wt %, based upon total weight percent of the treatment.

### Clay Suspending Agent

In embodiments, clays could be included in the above composition as fluid loss additives. The present inventors have further determined that non-surface active substituted ammonium containing aminoacid derivatives, and in particular substituted glycine when used in conjunction with one or more clays may be used enhance clay particle suspension ability. More specifically, the addition of non-surface active substituted ammonium containing aminoacid derivatives, and in particular substituted glycine may be added to mineral suspensions, such as, for example, particular clay suspensions can enhance the stability of the suspension and thus enable uses for extended periods of time. Clay suspensions may settle as a function of time, pH, salinity and temperature. In selected applications, such as, for example, sandstone acidizing, dirty carbonate stimulation, fluorite dispersion, and clay dissolution, it is desirable to maintain the clay suspension for as long as possible. Specifically, in sandstone acidizing, a clay dissolving acid such as hydrofluoric acid, hydrochloric acid, a hydrofluoric acid precursor such as ammonium biflouride, or hydrochloric acid precursor may result in the suspension of aluminosilicates, clays, silica, and fluorite, that should not deposit in the reservoir, and should remain in suspension until the fluid is flown back.

As defined herein, the term “clay” is defined as a group of hydrous aluminum phyllosilicates minerals that are generally less than 2 μm in diameter that consist of a variety of phyllosilicate minerals rich in various silicon and aluminum oxides and hydroxides in addition to variable amounts of structural water. Suitable examples of clays include organophillic clays, such kaolinite, halloysite, ATTAPULGITE, vermiculite, montmorillonite-smectite, illite, chlorite, bentonite and hectorite clays; and synthetic clays such as Laponite. Additional examples of clays include various types of “pure” or “natural clays”. For example, montmorillonite clay has a chemical formula of (Na, Ca)_{0.33}(Al,Mg)₂Si₄O₁₀(OH)₂nH₂O. Additional organophilic clays are described in U.S. Pat. Nos. 2,531,812, 3,831,678, 3,537,994 and 4,464,274, the disclosures of which are incorporated by reference herein in its entirety.

The non-surface active substituted ammonium containing aminoacid derivatives may act as environmentally friendly clay suspension enhancing agent when present in the fluid in amount of from about 1% to about 20% or from about 2 wt % to about 10 wt %, based upon total weight percent of the treatment.

### Cementing

In embodiments, non-surface active substituted ammonium containing aminoacid derivatives, and in particular substituted glycine may be used in formulations comprising cement as a coating for particulate additives used in the cementing operations to prevent these particles from freezing, clumping and/or achieve excessive cohesion in zonal isolation hardening, settable treatments. This may allow for granular materials to more easily flow, such as, for example, cement particles coated with substituted glycine could flow more easily, and thus minimize downtime in the field and eliminate various operational problems. Additionally, sand or proppants may be coated with the non-surface active substituted ammonium containing aminoacid derivatives, and in particular substituted glycine to flow more easily. Further, porous particles may be saturated with non-surface active substituted ammonium containing aminoacid derivatives, and in particular substituted glycine such that it is slowly released by diffusion. Also, fibers used in stimulation, cementing and work over fluids are also prone to suffer similar clumping, that can be avoided with non-surface active substituted ammonium containing aminoacid derivatives, and in particular substituted glycine coating. Further details regarding these materials are described in U.S. Pat. Nos. 8,091,642 B2, 7,947,127 8,042,614 B2, 5,501,275 A, each of which is incorporated by reference herein in its entirety.

Generally cementing a well consists of pumping a cement slurry from the surface down the casing so that it then returns towards the surface via the annulus between the casing and the borehole. One of the purposes of cementing a well is to isolate the different formation layers traversed by the well to prevent fluid migration between the different geological layers or between the layers and the surface. For safety reasons, it is also essential to prevent any gas rising through the annulus between the borehole wall and the casing.

When the cement has set, it is impermeable to gas. Because of the hydraulic pressure of the height of the cement column, the injected slurry is also capable of preventing such migration. However, there is a critical phase, between these two states which lasts several hours during which the cement slurry no longer behaves as a liquid but also does not yet behave as an impermeable solid. For this reason, additives, such as those described in U.S. Pat. Nos. 4,537,918, 6,235,809 and 8,020,618, the disclosures of which are incorporated by reference herein their entirety, may be added to maintain a gas-tight seal during the whole cement setting period.

The concept of fluid loss (discussed above in greater detail) is also an important property to control in cement slurries. Fluid loss occurs when the cement slurry comes into contact with a highly porous or fissured formation. Fluid from the cement slurry will migrate into the formation altering the properties of the slurry. When fluid loss occurs it makes the cement more permeable to gas. Performance of fluid loss control additives, can be enhanced by the use of antisettling agents such as non-surface active substituted ammonium containing aminoacid derivatives, and in particular substituted glycine, may be used to prevent or at least limit the fluid loss that may be sustained by the cement slurry during placement and its setting.

In addition, in locations where the climate is cold, such as Russia, Alaska, and Canada for example, liquid additives are not appropriate. In cold climates the liquid additives are difficult to handle as they become hard and therefore are not as pourable, which can lead to difficulties in proper mixing in the cement slurry.

In embodiments, described herein is an environmentally compatible cement retarding agents and methods of using such retarding agents in subterranean well fluids. Specifically, the cement retarding agent may comprises non-surface active substituted ammonium containing aminoacid derivatives, and in particular substituted glycine or derivatives thereof including the salts of trimethyl glycine hydrate, trimethyl glycine or betaine, or trimethylglycinic acid, or the hydrochloric acid adduct of trimethyl glycine.

In another other embodiment, described herein is a cement composition comprising a non-surface active substituted ammonium containing aminoacid derivatives, and in particular substituted glycine or derivatives thereof including the salts of trimethyl glycine hydrate, trimethyl glycine or betaine, or trimethylglycinic acid, or the hydrochloric acid adduct of trimethyl glycine as retarding agents, for Portland cement and water. The cement composition may further comprise at least one of Portland cement, water, an epoxy resin and a curing agent. Examples of cement compositions are described in U.S. Pat. Nos. 4,537,918 and 5,547,027 and Great Britain Patent No. 2385325, the disclosures of which are incorporated by reference herein in their entirety. The cement composition may also include TMG and clay component to provide fluid loss and retard Portland cement and water. Examples of suitable clays include those described above.

In embodiments, the cement composition comprising a non-surface active substituted ammonium containing aminoacid derivatives, and in particular substituted glycine, and clay combination may provide multiple beneficial features, such as (1) reducing the settling of Portland cement and water, (2) as a viscosity modifier and gel strength modifier of Portland cement and water and/or (3) an antifreeze agent of Portland cement and water, a corrosion inhibitor of surface equipment and down hole completions that employ high pH fluids (a pH greater than 11, such as for example, a pH of from 11-13.5) such as Portland cement and water.

Other additives suitable for use in subterranean cementing operations also may be added to embodiments of the cement compositions, in accordance with embodiments of the present application. Examples of such additives include, but are not limited to, strength-retrogression additives, set accelerators, set retarders, weighting agents, lightweight additives, gas-generating additives, mechanical property enhancing additives, lost-circulation materials, filtration-control additives, dispersants, a fluid loss control additive, defoaming agents, foaming agents, thixotropic additives, and combinations thereof. By way of example, the cement composition may be a foamed cement composition further comprising a foaming agent and a gas. Specific examples of these, and other, additives include crystalline silica, amorphous silica, fumed silica, salts, fibers, hydratable clays, calcined shale, vitrified shale, microspheres, fly ash, slag, diatomaceous earth, metakaolin, rice husk ash, natural pozzolan, zeolite, cement kiln dust, lime, elastomers, resins, latex, combinations thereof, and the like.

The non-surface active substituted ammonium containing aminoacid derivatives may act as a coating for particulate additives used in the cementing operations to prevent these particles from freezing, clumping and/or cohesion when present in the fluid in amount of from about 1% to about 20% or from about 2 wt % to about 10 wt %, based upon total weight percent of the solid particles. The foregoing is further illustrated by reference to the following examples, which are presented for purposes of illustration and are not intended to limit the scope of the present disclosure.

### EXAMPLES

### Freezing Point Depressant

To illustrate this embodiment, a series of formulations comprising a combination of a non-ionic surfactant Rhodasurf LA-3, water, isopropyl alcohol and substituted glycine's were prepared. This surfactant was selected as a proxy for many other surfactants and additives currently used in the oilfield as per embodiments in this application that may require to be “winterized”, a term that indicates the liquid additive freezing point is depressed to enable pumpability at low temperatures. The pumpability of each composition at 22° C. was qualitatively determined by pouring the formulations and visually qualifying their pourability and by qualitatively estimating their flammability based on the weight fraction of flammable components in the mixture. Similar results are expected with other surfactants, or with other oilfield additives. It is understood that tests like those described in the foregoing examples performed by those of skill in the art of formulating chemical additives for suitable well site delivery, will be required to determine the optimum composition and the extent of the improvement expected when using the non-surface active substituted ammonium containing aminoacid derivatives, and in particular the substituted glycines disclosed herein. The details for these formulations are shown below in Table 1.

TABLE 1

| | surfact- | | | | | | flam- |
|---|---|---|---|---|---|---|---|
| example | ant | water | IPA | TMG | Pourable | | mable? |
| # | g | g | g | g | Y/N | form | Y/N |
| Comp. | 20 | 0 | 0 | 0 | N | paste | N |
| Ex. 1 | | | | | | | |
| Comp. | 20 | 0 | 8 | 0 | Y | solution | Y |
| Ex. 2 | | | | | | | |
| Comp. | 20 | 12 | 8 | 0 | Y | solution | Y |
| Ex. 3 | | | | | | | |
| Ex. 1 | 20 | 12 | 6 | 6 | Y | solution | Y |
| Ex. 2 | 20 | 12 | 4 | 8 | Y | solution | Y |
| Ex. 3 | 20 | 12 | 0 | 8 | Y | emulsion | N |
| Comp. | 20 | 12 | 0 | 0 | N | Gel | N |
| Ex. 4 | | | | | | | |

As can be seen from Table 1, by comparing the pourability of the different additive formulations prepared, the selected surfactant cannot be delivered and metered in the form supplied by the chemical manufacturer (reference, comparative example O, paste), or even after dilution with water (Comp. Ex. 4—gel). On the other hand, to ensure the surfactant additive can be delivered and metered in the form of a solution, a freezing point depressant such as isopropyl alcohol (“IPA”—Comp. Ex. 2 and 3) may be added. IPA is a flammable solvent that is volatile and should not be inhaled, hence the use of water/IPA mixtures allows to still render the additive pumpable (Comp. Ex. 3) and to try to minimize flammability, at the expense of increasing the maximum temperature at which the surfactant can be poured.

On the other hand, as also shown in Table 1, the pourability of the surfactant additive may enhanced by adding TMG to the IPA/water mixture, while minimizing the additive flammability and reducing the total concentration of IPA (Ex. 1 and Ex. 2). Furthermore, Ex. 3 illustrates that completely eliminating the IPA renders the additive pumpable in the form of a low viscosity emulsion. In addition, the formulations that do not include IPA at all are considered non-flammable.

Those of skill in the art would appreciate that while these examples have been formulated with a particular additive, a surfactant, several other additives, could be formulated with a similar intend of being pumped at low ambient temperatures. Examples include, but are not restricted to: other surfactants, foamers, clay stabilizers, crosslinkers, activators, inorganic and organic scale inhibitors, fines migration additives, pH buffers, chelating agents, acids, bases, iron control agents, delay agents, and the like. Specific examples of some of these materials are described above.

### Breaker Examples

Four breaker compositions were prepared for borate based crosslinked fluids (Examples 4-6 and Comparative Ex. 5) and four breaker compositions were prepared for zirconium based crosslinked fluids (Examples 7-9 and Comparative Example 6). As a reference for Example 4, guar gum was fully hydrated in a Waring blender at a specific polymer concentration in a brine containing a specific amount of TMG for 30 minutes. The amphoteric surfactant, the borate crosslinker and the sodium hydroxide were added in a blender and mixed for 1 minute, and the resulting fluid was subsequently brought to the rheometer for viscosity evaluation. These experiments were repeated for Examples 5-6 and Comparative Example 7, except that the amount of TMG was changed. Similarly for Example 7, a self-hydrating guar derivative (CMHPG) was fully hydrated in a Waring blender at a specific polymer concentration in a brine containing a specified amount of TMG for 30 minutes. A multifunctional additive (clay stabilizer, crosslinker enhancer, and flow back additive mixture), the amine stabilizer, the zirconium crosslinker, and the sodium hydroxide activator were added in a blender and mixed for 1 minute, and the resulting fluid was subsequently brought to the rheometer for viscosity evaluation. These experiments were repeated for Examples 7-9 and Comparative Example 6, except that the amount of TMG was changed.

The details for these eight breaker compositions are summarized below in Table 2. No additional breaker was added to the formulations.

TABLE 2

| | | | | Sodium | Clay | Borate | | Zirconium | |
|---|---|---|---|---|---|---|---|---|---|
| | | | | Hydroxide | stabilizer & | Based | | Based | |
| | Gelling | Amphoteric | Amine | Gelling | surfactant | Crosslinker | | Crosslinker | TMG |
| | Agent | Surfactant | Stabilizer | Agent | additive | Composition | 10% NaOH | Composition | (wt. % in |
| | (ppt) | (gpt) | (gpt) | (gpt) | (gpt) | (gpt) | Solution | (gpt) | water) |
| Example 4 | 18.0 | 1 | — | 2 | — | 1.5 | — | — | 10 |
| Example 5 | 18.0 | 1 | — | 2 | — | 1.5 | — | — | 20 |
| Example 6 | 18.0 | 1 | — | 2 | — | 1.5 | — | — | 50 |
| Comparative | 18.0 | 1 | — | 2 | — | 1.5 | — | — | — |
| Ex. 5 | | | | | | | | | |
| Example 7 | 25.0 | — | 1 | — | 4.5 | — | 2 | 1.8 | 10 |
| Example 8 | 25.0 | — | 1 | — | 4.5 | — | 2 | 1.8 | 20 |
| Example 9 | 25.0 | — | 1 | — | 4.5 | — | 2 | 1.8 | 50 |
| Comparative | 25.0 | — | 1 | — | 4.5 | — | 2 | 1.8 | — |
| Ex. 6 | | | | | | | | | |

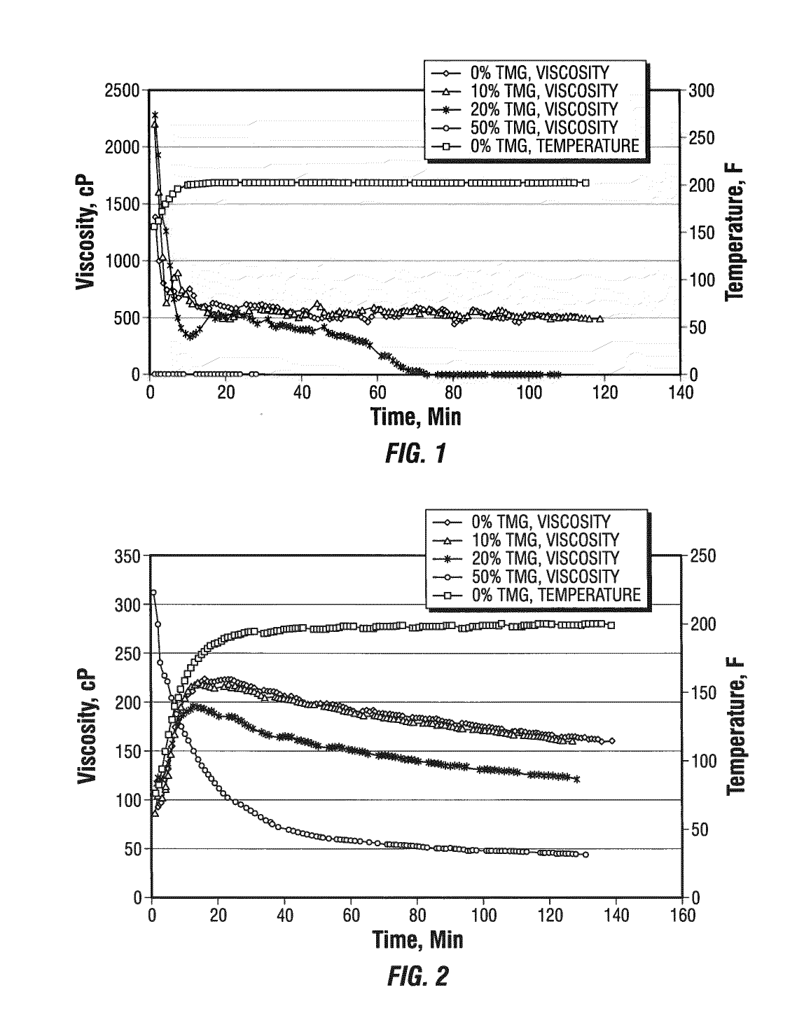

The viscosity for the eight breaker compositions over time was measured using a Grace M5600 rheometer using a B5 bob (1.5987 cm diameter and 7.62 cm in length) and R1 rotor at a constant shear rate of 100 s⁻¹. The viscosity was measured at 200° F. (93.3° C.). The viscosity was then plotted, as shown in FIGS. 1-2 below.

As shown in FIGS. 1-2, there is a range of concentrations where the addition of a non-surface active substituted ammonium containing aminoacid derivatives, such as TMG, to the fracturing fluid does not result in a substantial loss of viscosity compared to the fluid without a non-surface active substituted ammonium containing aminoacid derivatives (below 10 wt %), and a range of concentrations where the fluid is substantially broken shortly after it is brought to operating temperature. Since substituted glycines are 100% soluble in the fluid, it may have the ability to migrate with the fluid into the pore space, and break the fluid within the pore space.

Therefore, breaker compositions containing in an amount of from about 10 wt. % to about 50 wt % of a non-surface active substituted ammonium containing aminoacid derivatives, such as TMG, result in partial breaking of the fluid in both borate (Examples 5 &6) and zirconate crosslinked fluids (Examples 8 & 9). Therefore, substituted glycines may be employed as a delayed breaker for fracturing and sand control fluids, providing additional benefits such as improved freeze point reduction of the fluid.

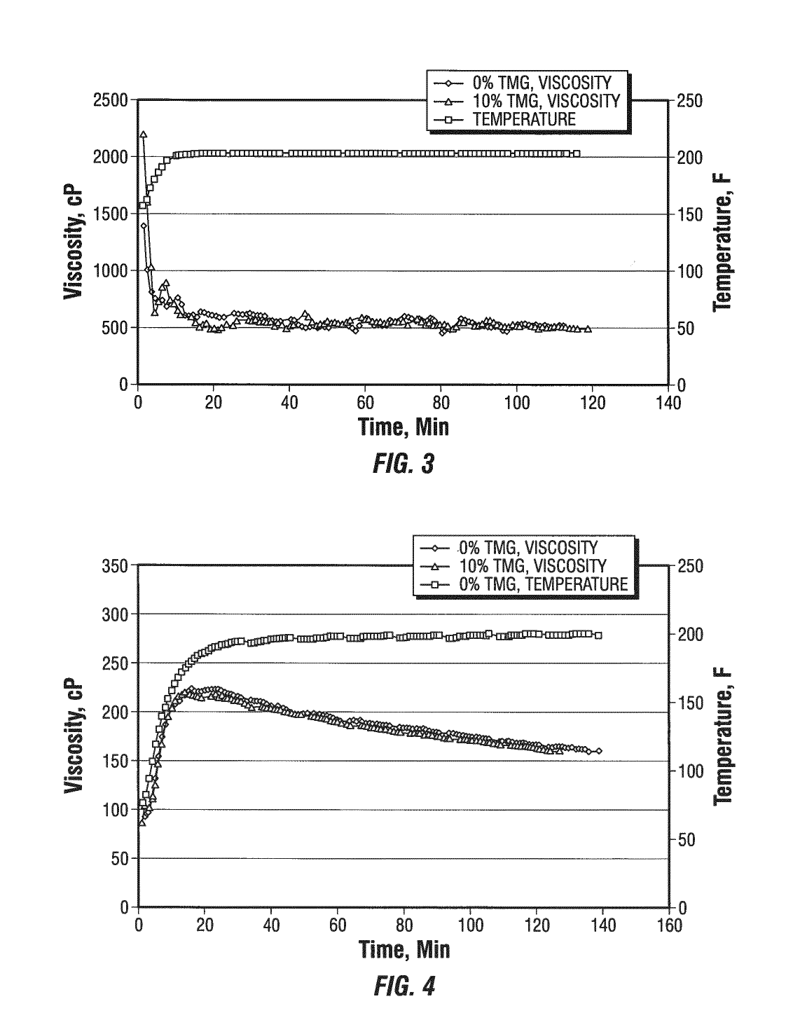

In addition the experiments performed show that there is a range of concentrations of TMG, where improvement on the freezing point depression can be observed, whilst no effect on the fluid stability (breaking) is noticed. The selected formulations can be used in treatments where the surface treating temperatures is low and depressing or reducing the freezing point of the fluid might be appropriate. For example, such a temperature may be a subterranean formation where the bottom hole static temperature (BHST) is from about 100 to about 250° F. and the ambient temperature (and the mix water temperature) is substantially below 0° C. Comparison of Experiments 4 and Comparative Ex. 5 in Table 2, as illustrated in FIG. 3, shows no difference in fluid viscosity although a substantial freeze point depression can be obtained with the sample containing 10% TMG (Example 4).

To further illustrate this embodiment, two additional treatment fluid composition (Example 7, and Comparative Ex. 6, Table 2) zirconate-crosslinked polymer fluids are considered. The preparation of these fluids are described in detail above. In this case the formulation in Example 7 provided additional freezing protection over the formulation in Comparative Ex. 6 where no TMG is used as fluid freezing point depressant, while the viscosity yield at bottom hole static temperature (200° F.) as shown in FIG. 4 was analogous.

As shown in FIGS. 3 and 4, the application of a non-surface active substituted ammonium containing aminoacid derivatives, such as TMG, in a specific concentration in guar borate crosslinked fluids and guar derivative zirconium crosslinked fluids can result in a negligible loss the fluid viscosity, replacing a less environmentally concerning solvent such as methanol, in the form of a non-flammable fluid, whilst still maintaining an effective freeze point depression, and hence ensuring the pumpability of the treatment fluid.

### Fluid Loss Examples

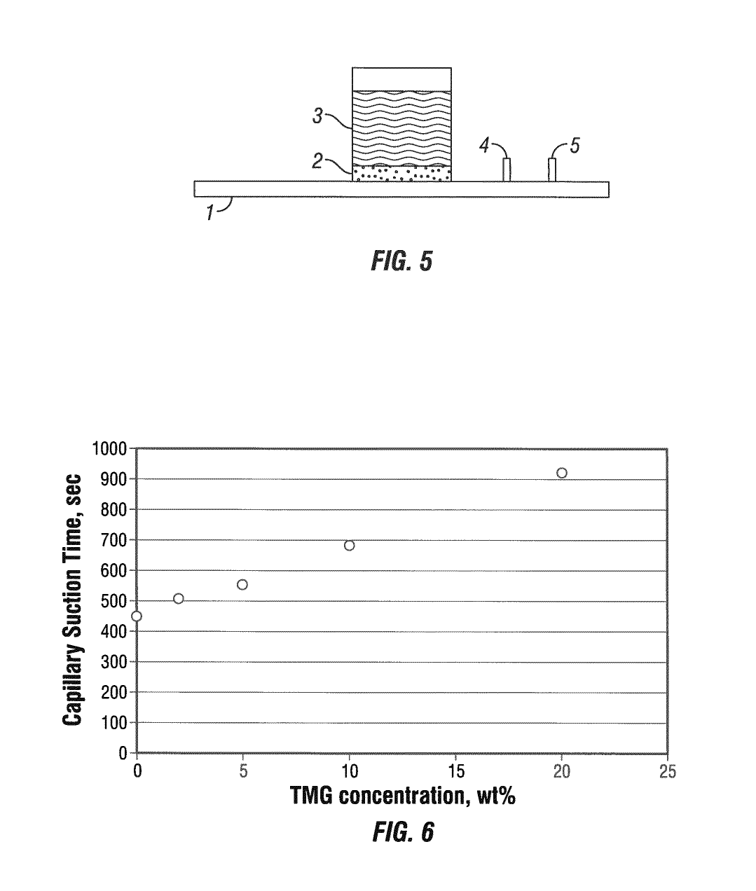

To further illustrate this embodiment, a radial capillary suction time (CST) apparatus from Ventura Inc. (as illustrated in FIG. 5) was used to measure the filterability of a particle suspension fluid 3 comprised of a bentonite clay (GEL SUPREME from MI-Swaco), water and various concentrations of trimethyl glycine (TMG). The trimethyl glycine was obtained from Sigma Aldrich and possessed a melting point of 301° C. The GEL SUPREME was a sodium montmorillonite clay that is not chemically treated. The CST further contained a filter paper 1 (Whatman #17 having a pore size of 8 microns) and a filtercake 2.

After pouring each of the various fluids into the CST, electrical conductance sensors 4 and 5 determined the capillary suction time by measuring the amount of time for the fluid 3 to travel a radius located at sensor 4 to a different radius located at sensor 5. These details are summarized below in Table 3 and FIG. 6.

TABLE 3
Amounts of Materials in Examples 10-13 and Comp. Ex. 7

| | Concentration | Amount of | |
|---|---|---|---|
| | of TMG, % | Bentonite, g | Capillary |
| | Per 100 g | Per 20 mL of | Suction |
| | of Water | TMG solution | Time (sec) |
| Comp. Ex. 7 | 0 | 0.2 | 460 |
| Example 10 | 2 | 0.2 | 510 |
| Example 11 | 5 | 0.2 | 560 |
| Example 12 | 10 | 0.2 | 690 |
| Example 13 | 20 | 0.2 | 920 |

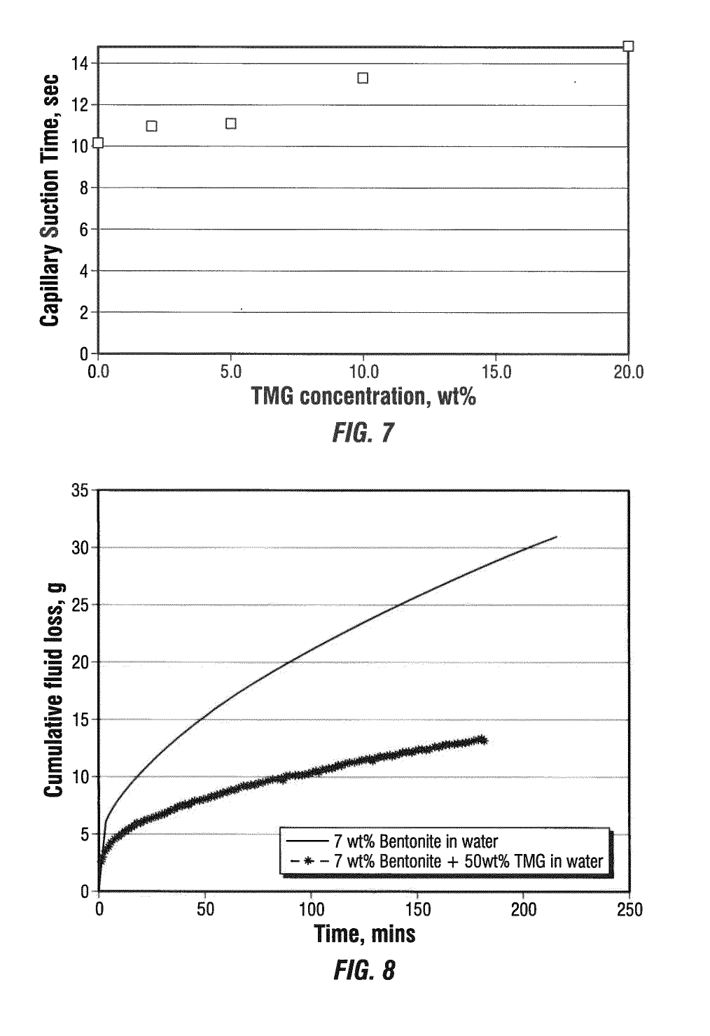

Five additional fluid samples were prepared in the exact same manner as Comp. Ex. 8 and Examples 10-13 except that the solution contained only TMG (no clay). These results are summarized below in Table 4 and FIG. 7.

TABLE 4
Amounts of Materials in Comparative Ex. 8 - Comparative Ex. 12.

| | Concentration | Amount of | |
|---|---|---|---|
| | of TMG, % | Bentonite, g | Capillary |
| | Per 100 g | Per 20 mL of | Suction |
| | of Water | TMG solution | Time (sec) |
| Comp. Ex. 8 | 0 | — | 10 |
| Comp. Ex. 9 | 2 | — | 11 |
| Comp. Ex. 10 | 5 | — | 11 |
| Comp. Ex. 11 | 10 | — | 13 |
| Comp. Ex. 12 | 20 | — | 15 |

As shown in FIG. 6 (and Table 3), the filterability of the clay suspension was fast in the absence of TMG and hence the CST was short, 460s. However, as the concentration of TMG was increased, the filterability of the clay suspension decreased and thus the CST time increased up to 920s when 20% TMG was used. Furthermore, as shown in FIG. 7 (and Table 4), the influence of TMG alone on the CST was negligible compared with the CST of TMG and clay suspension with all results between 10 and 15 s, much lower than any results comprising bentonite, which suggests a synergistic effect between the clay and TMG that reduces the fluid loss.

To determine whether the presence of a non-surface active substituted ammonium containing aminoacid derivatives, such as TMG, may reduce fluid loss, a filtration test was performed at 100 psi and 25° C. on a 2.4 micron filter paper using a 7 wt % bentonite slurry (1) with 50 wt % TMG and (2) without TMG.

As shown in FIG. 8, the presence of TMG reduced the fluid loss (both spurt—ordinate, and wall building coefficient—slope) by a factor of at least 2. Based upon this information, one may conclude that the use of a non-surface active substituted ammonium containing aminoacid derivatives, and in particular substituted glycine, in combination with suspended clays can enhance the fluid loss capability of the clay itself.

### Clay Suspension

To determine the effect of a non-surface active substituted ammonium containing aminoacid derivatives, such as, substituted glycine on the clay (GEL-SUPREME) suspension capability, various slurries were prepared by adding 1 wt % and 5 wt % of bentonite clay to solutions of 0 wt %, 10 wt % and 20 wt % of substituted glycine in water. The slurry was centrifuged for 10 minutes at 3000 rpm using an ultra-centrifuge to simulate an accelerated settling process and the clarity of the suspension was observed.

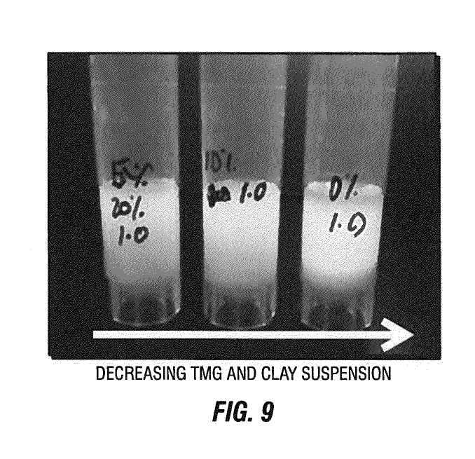

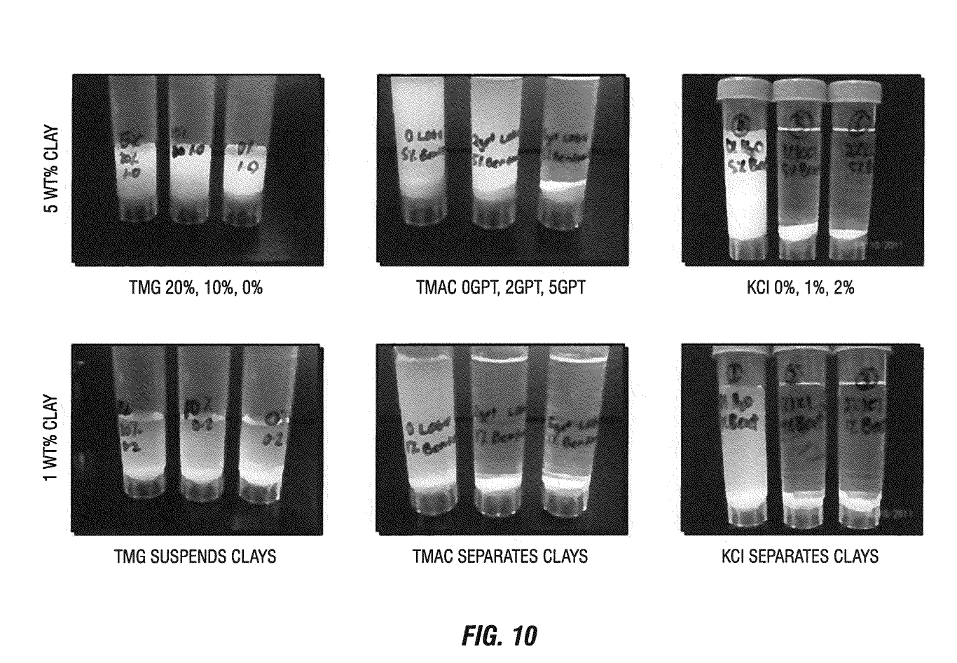

For comparison, 1 wt % and 5 wt % bentonite clays were also added to solutions of tetra methyl ammonium chloride (TMAC) and potassium chloride (KCl). The concentration of TMAC in these solutions were 0, 2 and 5 gallons per thousand (gpt) and the KCl concentration was 0%, 1% and 2% w/w. The results for these examples are shown below in FIGS. 9 and 10.

As shown in FIGS. 9 and 10, the clarity of the centrifuged samples decreased as the concentration of TMG for both concentrations of clay was increased. However, in the presence of the conventional clay stabilizers such as TMAC and KCl, the clay settled rapidly in these solutions in contrast to solutions containing TMG. TMG was found to be an effective suspending agent. Based upon this information, it is believed that TMG may assist in the suspension of clay particles.

### Cementing Examples

### Cement Retardation

A multitude of cement slurries was prepared using various amounts of TMG in the slurry ranging 0.3% by weight of cement (BWOC) to 50% BWOC. The water to cement weight ratio was kept constant at 0.4. Comparative examples were prepared in the exact same manner as the cement slurry examples except that the comparative examples did not contain any TMG. Prior to evaluating the cement slurries, a qualitative rating system was developed and described in detail below in Table 5.

TABLE 5
Rating Of Consistency Of Cement Slurry

| Qualitative | |
|---|---|
| rating | Comments |
| 1 | Viscous, mediun flowing |
| 2 | Not set. Slow flowing. Thick viscous |
| 3 | Not set. Some gellation. |
| 4 | Not set. Some gellation. No flow. Puddle rod retrieves |
| | sample |
| 5 | Not fully set. No Flow. Heavy gellation. Surface disturbed |
| 6 | Setting. Sponge-like surface |
| 7 | Fully Set. Hard surface |

The consistency of cement formulations exclusively comprising of water and cement, and various amounts of TMG was monitored with time by first forming a cement slurry comprised of the materials described below and then allowing the slurry to set at room temperature (RT) and also at 150° F. in an oven. These composition details and consistency rating of each of the above examples are summarized below in Table 6 below.

TABLE 6
Evaluation Data for Cement Retardation

| | | | Qualitative Rating of Slurry | | | | |
|---|---|---|---|---|---|---|---|
| | Formulation | Temp. (° F.) | 1 hr | 2 hrs | 3 hrs | 4 hrs | 6 hrs |
| Comp. Ex. 13A | Water/Cement | RT | 1 | 1 | 1 | 2 | 3-4 |
| Comp. Ex. 13B | Water/Cement | 150 | 2 | 3 | 6 | 7 | — |
| Ex. 14A | 0.3% TMG BWOC | RT | 1 | 1 | 1 | 2 | 3-4 |
| Ex. 14B | 0.3% TMG BWOC | 150 | 2 | 6 | 7 | — | — |
| Ex. 15A | 0.5% TMG BWOC | RT | 1 | 1 | 1 | 2-3 | 5 |
| Ex. 15B | 0.5% TMG BWOC | 150 | 1-2 | 6 | 7 | — | — |
| Ex. 16A | 1% TMG BWOC | RT | 1 | 1 | 1 | 2 | 4 |
| Ex. 16B | 1% TMG BWOC | 150 | 1-2 | 5 | 6-7 | 7 | — |
| Ex. 17A | 2% TMG BWOC | RT | 1 | 1 | 1 | 2 | 3 |
| Ex. 17B | 2% TMG BWOC | 150 | 1-2 | 4 | 6 | 7 | — |
| Ex. 18A | 5% TMG BWOC | RT | 1 | 1 | 1 | 1 | 2 |
| Ex. 18B | 5% TMG BWOC | 150 | 1-2 | 2 | 4-5 | 6 | — |
| Ex. 19A | 10% TMG BWOC | RT | 1 | 1 | 1 | 1 | 2 |
| Ex. 19B | 10% TMG BWOC | 150 | 1-2 | 2 | 2 | 3 | 5 |
| Ex. 20A | 20% TMG BWOC | RT | 1 | 1 | 1 | 1 | 1 |
| Ex. 20B | 20% TMG BWOC | 150 | 1 | 1-2 | 2 | 2 | 2 |
| Ex. 21A | 50% TMG BWOC | RT | 1 | 1 | 1 | 1 | 1 |
| Ex. 21B | 50% TMG BWOC | 150 | 1 | 1 | 1 | 1 | 1 |

As shown above in Table 6, at room temperature (RT), the retardation of cement was observed at 2% BWOC TMG concentration, and at 150° F., the retardation was observed at concentrations of 10% BWOC TMG and higher. At TMG concentration of as high as 50% BWOC, the cement did not set. These results demonstrate that non-surface active substituted ammonium containing aminoacid derivatives may be employed as retarding agents for compositions of Portland cement and water.

Additional examples were prepared to further demonstrate the ability of non-surface active substituted ammonium containing aminoacid derivatives to retard other more complex cement compositions. The consistency of an organic cement formulation comprising water, cement and cured waterborne epoxy slurry containing TMG was monitored by first forming a slurry comprised of water, cement, a waterborne epoxy resin and curing agent and allowing the slurries to set at room temperature (RT) and at 150° F. in an oven. The waterborne epoxy resin used in each of the slurries was EPI-REZ 6006-W-68, manufactured by Momentive. The curing agent used in each of the slurries of Example 20 was EPIKURE 3300, manufactured by Momentive. Furthermore, the concentration of TMG in the slurries of ranged from 5% to 10% BWOC, and the water to cement ratio by weight was kept constant at 0.40, whereas the ratio crosslinked resin to cement was kept constant at 0.62. Using the qualitative rating shown in Table 6, the consistency of the slurry was evaluated. The details for these slurries are described in further detail below in Table 7, which include the consistency rating with time and formulation.

TABLE 7
Evaluation Data for Cement Retardation

| | | Temp. | Cement | Epoxy Resin | Curing Agent | Qualitative Rating of Slurry | | | | |
|---|---|---|---|---|---|---|---|---|---|---|
| | Formulation | (° F.) | (g) | (g) | (g) | 1 hr | 2 hrs | 3 hrs | 4 hrs | 6 hrs |
| Comp. | 0% TMG | RT | 30 | 43.75 | 5.07 | 3 | 3 | 4-5 | 5 | 5-6 |
| Ex. 14A | | | | | | | | | | |
| Comp. | 0% TMG | 150 | 30 | 43.75 | 5.07 | 3 | 3 | 4 | 6 | 7 |
| Ex. 14B | | | | | | | | | | |
| Ex. 22A | 5.0% TMG | RT | 30 | 43.75 | 5.07 | 1 | 2 | 2-3 | 3 | 4-5 |
| | BWOC | | | | | | | | | |
| Ex. 22B | 5.0% TMG | 150 | 30 | 43.75 | 5.07 | 4-5 | 5 | 6 | 7 | — |
| | BWOC | | | | | | | | | |
| Ex. 23A | 10% TMG | RT | 30 | 43.75 | 5.07 | 1 | 1 | 1 | 2 | 2 |
| | BWOC | | | | | | | | | |
| Ex. 23B | 10% TMG | 150 | 30 | 43.75 | 5.07 | 5 | 6 | 6 | 7 | — |
| | BWOC | | | | | | | | | |

As shown above in Table 7, the data demonstrates that increasing the concentration of TMG retards the cement particularly at room temperature. Comparison of room temperature testing for Comparative Example 14A, Example 22A and Example 23A shows that increasing concentrations of TMG can provide additional delay (lower gel rating at longer times). On the other hand, the 150° F. delay is similar at all TMG concentrations (Comparative Example 14B and Examples 22B and 23B) indicating that the positive impact of TMG as a retarder at low temperature does not result in a negative impact preventing appropriate gel strength development at BHST such as 150° F.

### Gel Strength

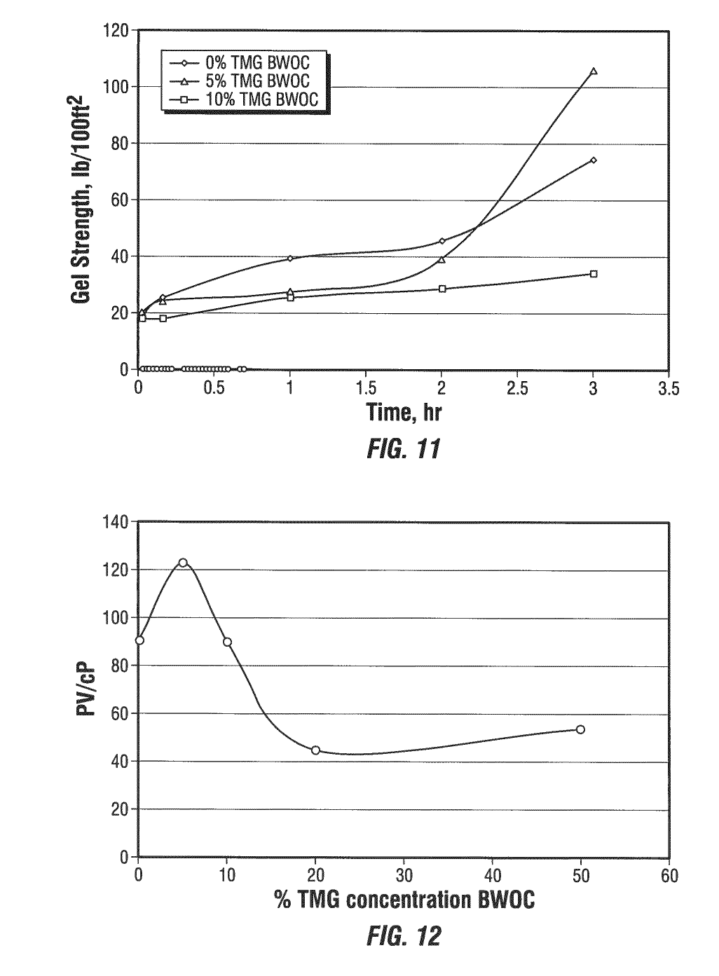

A Fann 35 viscometer was used to measure the gel strength with time and plastic viscosity of various cement slurries at room temperature at RT prepared with amounts of TMG ranging from 0% to 50% BWOC. These cement slurries were prepared following the same procedure and formulation as the cement slurries of Examples 34-37, except with varying amounts of TMG. The gel strength of the cement formulation is important to ensure that the particles do not settle and thus result in an unstable slurry. The build-up of the gel strength is an indicator of the cement beginning to set, and a suitable viscosity is important to ensure that the slurry is pumpable. The results are illustrated in FIGS. 11 and 12.

As shown in FIG. 11, the build-up of gel strength increased sharply after 1.5 hours in the absence of TMG. However, the presence of 5% BWOC TMG, the build-up in gel strength was delayed was for approximately 2 hours and in the case of 10% BWOC TMG the build-up in gel strength delay was greater than 3 hours. This highlights the impact of TMG as a retarder, preventing early gel strength development, and ensuring the cement does not set during pumping. In addition FIG. 12 shows that appropriate levels of plastic viscosity (similar to the baseline result obtained in the absence of TMG) can be obtained with concentrations of TMG up to 10% BWOC, and that increasing the concentration of TMG up to 20% or higher might result in a reduction of the plastic viscosity below that of the reference point at 0% TMG.

Although only a few example embodiments have been described in detail above, those skilled in the art will readily appreciate that many modifications are possible in the example embodiments without materially departing from the disclosure of ADDITIVE FOR SUBTERRANEAN TREATMENT. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112(f) for any limitations of any of the claims herein, except for those in which the claim expressly uses the words ‘means for’ together with an associated function.

What is claimed is:

1. A method of treating a subterranean formation, the method comprising:
forming a treatment fluid comprised of at least a non-surface active substituted ammonium containing aminoacid derivative; and
introducing the treatment fluid to the subterranean formation.

2. The method for treating a subterranean formation of claim 1, wherein the non-surface active substituted ammonium containing aminoacid derivatives is a material of formula (1)
R₁R₂R₃N⁺—R₄—CO₂⁻ (1)
wherein R₁, R₂, and R₃, are, independently of each other, short chain hydrocarbon structures of the same or different nature, and R₄ is an n-alkylene radical selected from the group consisting of methylene, ethylene, propylene, butylene, and the like.

3. The method for treating a subterranean formation of claim 1, wherein the non-surface active substituted ammonium containing aminoacid derivatives is a material of formula (1)
R₁R₂R₃N⁺—R₄—CO₂⁻ (1)
wherein R₁, R₂, and R₃, are, independently of each other, short chain hydrocarbon structures of the same or different nature, and R₄ is an amino or hydroxyl containing hydrocarbon chain.

4. The method for treating a subterranean formation of claim 1, wherein the non-surface active substituted ammonium containing aminoacid derivatives is a material having the chemical formula (2)
[R₁R₂R₃N⁺—R₄—CO₂H]A⁻ (2)
wherein R₁, R₂, and R₃, are, independently of each other, short chain hydrocarbon structures of the same or different nature, R₄ is an n-alkylene radical selected from the group consisting of methylene, ethylene, propylene, butylene, and the like and A⁻ is the conjugated base of a neutralizing monoprotic acid.

5. The method for treating a subterranean formation of claim 1, wherein the non-surface active substituted ammonium containing aminoacid derivatives is a material having the chemical formula (3)
[R₁R₂R₃N⁺—R₄—CO₂]_{z}M (3)
wherein R₁, R₂, and R₃, are, independently of each other, short chain hydrocarbon structures of the same or different nature, and R₄ is an n-alkylene radical selected from the group consisting of methylene, ethylene, propylene, butylene, and the like, and wherein M is a metal ion of charge positive charge, z is an integer between +1 and +4,

6. The method for treating a subterranean formation of claim 1, wherein the non-surface active substituted ammonium containing aminoacid derivatives is a material having the chemical formula (4)
[R₁R₂R₃N⁺—R₄—CO₂H]ₜA^{t-} (4)
wherein R₁, R₂, and R₃, are, independently of each other, short chain hydrocarbon structures of the same or different nature, R₄ is an n-alkylene radical selected from the group consisting of methylene, ethylene, propylene, butylene, and the like and wherein A^{t-} is the conjugated base of a polyprotic neutralizing acid of charge t−, where t is an integer between 2 and 4.

7. The method for treating a subterranean formation of claim 1, wherein the non-surface active substituted ammonium containing aminoacid derivatives is a trialkyl glycine, selected from the group of trimethyl glycine, carnitine and acetyl carnitine

8. The method for treating a subterranean formation of claim 1, wherein the composition further contains particulates having one or more different shapes and sizes and/or having a positive charge, a negative charge, or combinations thereof.

9. The method for treating a subterranean formation of claim 1, wherein the non-surface active substituted ammonium containing aminoacid derivatives is trimethyl glycine (TMG).

10. The method for treating a subterranean formation of claim 1, wherein the treatment fluid is a slurry.

11. The method for treating a subterranean formation of claim 1, wherein the treatment fluid further comprises at least one material selected from the group consisting of fly ash, a silica compound, a fluid loss control additive, an emulsion, latex, a dispersant, an accelerator, a retarder, a salt, mica, sand, a fiber, a formation containing agent, fumed silica, bentonite, a microsphere, a carbonate, barite, hematite, an epoxy resin and a curing agent.

12. The method for treating a subterranean formation of claim 1, wherein the non-surface active substituted ammonium containing aminoacid derivative is encapsulated so that the non-surface active substituted ammonium containing aminoacid derivative is released downhole at a pre-set time.

13. The method for treating a subterranean formation of claim 1, wherein the fluid further comprises a hydratable polymer.

14. The method for treating a subterranean formation of claim 1, wherein the fluid is an aqueous fluid.

15. The method for treating a subterranean formation of claim 1, wherein the fluid further comprises one or more additives selected from the group consisting of crosslinkers, biocides, surfactants, activators, stabilizers and breakers.

16. The method for treating a subterranean formation of claim 1, wherein the fluid is selected from the group consisting of a fracturing fluid, well control fluid, well kill fluid, well cementing fluid, acid fracturing fluid, acid diverting fluid, a stimulation fluid, a sand control fluid, a completion fluid, a wellbore consolidation fluid, a remediation treatment fluid, a spacer fluid, a drilling fluid, a frac-packing fluid, water conformance fluid and gravel packing fluid.

17. The method for treating a subterranean formation of claim 1, wherein the treatment fluid is a fracturing fluid.

18. The method for treating a subterranean formation of claim 1, wherein the treatment fluid is contacted with a metal component that is corrodible to inhibit corrosion of the metal component.

19. The method for treating a subterranean formation of claim 1, wherein the treatment fluid further comprises one or more clays and the non-surface active substituted ammonium containing aminoacid derivative stabilizes and/or suspends the one or more clays in the treatment fluid.

20. The method for treating a subterranean formation of claim 1, wherein the treatment fluid further comprises cement and the treating is a cementing application.

21. The method for treating a subterranean formation of claim 1, wherein the treatment fluid further comprises multivalent cationic species selected from alkaline earth ions or transition metal ions.

22. The method for treating a subterranean formation of claim 1, wherein the treatment fluid further comprises at least one oxidative breaker.

23. The method for treating a subterranean formation of claim 1, wherein the treatment fluid exhibits a decrease in its freezing point.

24. The method for treating a subterranean formation of claim 1, wherein the treatment fluid exhibits a delay in the development of a particular rheological property.
